(19) United States
(12) Patent Application Publication
(10) Pub. No.: US 2022/0310302 A1
(43) Pub. Date: Sep. 29, 2022

(54) INTEGRATED MAGNETIC CORE AND WINDING LAMINA

(71) Applicant: Texas Instruments Incorporated, Dallas, TX (US)

(72) Inventors: Yi Yan, Sunnyvale, CA (US); Zhemin Zhang, Allen, TX (US); Ken Pham, San Jose, CA (US); Vijaylaxmi Khanolkar, Pune (IN); Dongbin Hou, Plano, TX (US)

(21) Appl. No.: 17/215,457

(22) Filed: Mar. 29, 2021

(51) Int. Cl. H01F 27/26; H01F 27/28; H01F 41/02; H01F 41/06

(52) U.S. Cl. CPC H01F 27/26; H01F 27/2823; H01F 41/0206; H01F 41/06

(57) ABSTRACT

A microelectronic device includes a magnetic component having a first magnetic core segment and a second magnetic core segment, with a winding lamina between them. The first magnetic core segment includes a winding support portion with ferromagnetic material. The winding lamina is attached to the winding support portion. The first magnetic core segment also includes an extension portion with ferromagnetic material extending from the winding support portion. The winding lamina has winding loops of electrically conductive material that surround ferromagnetic material. A filler material is formed between the winding lamina and the first magnetic core segment, contacting both the winding lamina and the first magnetic core segment. The second magnetic core segment is attached to the extension portion of the first magnetic core segment. The second magnetic core segment includes ferromagnetic material. The winding loops are electrically coupled to external leads through electrical connections.

### TECHNICAL FIELD

This disclosure relates to the field of microelectronic devices. More particularly, but not exclusively, this disclosure relates to magnetic components in microelectronic devices.

### BACKGROUND OF THE INVENTION

Isolation transformers typically are wire wound transformers, which are large and expensive. There is a big demand for a small, affordable isolation transformer suitable for integration on substrates with integrated circuits and such. To shrink the size of such transformers, while maintaining high isolation and reliability is challenging.

### SUMMARY OF THE INVENTION

The present disclosure introduces a microelectronic device including a first magnetic core segment and a second magnetic core segment, with a winding lamina between them. The first magnetic core segment includes a winding support portion that includes ferromagnetic material. The winding lamina is attached to the winding support portion by an adhesive material. The first magnetic core segment also includes an extension portion that includes ferromagnetic material. The extension portion extends from the winding support portion. The winding lamina has winding loops of electrically conductive material that surround ferromagnetic material.

A filler material is located between the winding lamina and the first magnetic core segment, contacting both the winding lamina and the first magnetic core segment. The filler material has a composition different from the adhesive material. The second magnetic core segment is attached to the extension portion of the first magnetic core segment. The second magnetic core segment includes ferromagnetic material. The microelectronic device includes external leads, and includes electrical connections between the winding loops and the external leads.

The microelectronic device may be formed by attaching the winding lamina to the winding support portion of the first magnetic core segment using the adhesive material. The filler material is subsequently introduced between the winding lamina and the first magnetic core segment, contacting both the winding lamina and the first magnetic core segment. The second magnetic core segment is subsequently attached to the extension portion. The electrical connections are formed between the winding loops and the external leads.

### BRIEF DESCRIPTION OF THE FIGURES

FIG. 1A through FIG. 1V are alternately top views and cross sections of an example microelectronic device including a magnetic component, depicted in successive stages of an example method of formation.

FIG. 2A through FIG. 2P are alternately top views and cross sections of another example microelectronic device including a magnetic component, depicted in successive stages of another example method of formation.

FIG. 3A through FIG. 3N are alternately top views and cross sections of a further example microelectronic device including a magnetic component, depicted in successive stages of a further example method of formation.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

In addition, although some of the embodiments illustrated herein are shown in two dimensional views with various regions having depth and width, it should be clearly understood that these regions are illustrations of only a portion of a device that is actually a three dimensional structure. Accordingly, these regions will have three dimensions, including length, width, and depth, when fabricated on an actual device. Moreover, while the present invention is illustrated by embodiments directed to active devices, it is not intended that these illustrations be a limitation on the scope or applicability of the present invention. It is not intended that the active devices of the present invention be limited to the physical structures illustrated. These structures are included to demonstrate the utility and application of the present invention to presently preferred embodiments.

A microelectronic device includes a magnetic component having a first magnetic core segment and a second magnetic core segment, with a winding lamina between them. The magnetic component may be manifested as an isolation transformer, a step-up transformer, a step-down transformer, or an inductor, for example.

The first magnetic core segment includes a winding support portion that includes ferromagnetic material. The first magnetic core segment also includes an extension portion that includes ferromagnetic material. The extension portion extends from the winding support portion.

The winding lamina is attached to the winding support portion by an adhesive material. The winding lamina has winding loops of electrically conductive material that surround ferromagnetic material. The ferromagnetic material surrounded by the winding loops may be part of the first magnetic core segment, or may be part of the second magnetic core segment.

The magnetic component includes a filler material between the winding lamina and the first magnetic core segment, contacting both the winding lamina and the first magnetic core segment. The filler material has a composition different from the adhesive material. The filler material may be free of voids between the winding lamina and the first magnetic core segment, which may advantageously improve reliability of the magnetic component compared to a similar magnetic component having voids. Voids are regions of air or other gas, surrounded by the filler material.

The second magnetic core segment is attached to the extension portion of the first magnetic core segment. The second magnetic core segment includes ferromagnetic material. The microelectronic device may be packaged as a dual in-line package, a single in-line package, a quad flat no-leads package, a quad flat package, a small outline package, or other package type. The microelectronic device includes external leads, and further includes electrical connections between the winding loops and the external leads.

The filler material is distinguishable from any of the adhesive materials used to attach elements of the magnetic component. For example, the filler material may have a lower volume content of filler particles than the adhesive materials, or may have filler particles with different shapes and sizes from filler particles in the adhesive materials. The filler material may have a different color from the adhesive materials. Differences between the filler material and the adhesive materials may be observed in cross sectioned devices or deconstructed devices using optical microscopy or electron microscopy.

For the purposes of this disclosure, the terms “lateral” and “laterally” refer to a direction parallel to a surface of the winding support portion to which the winding lamina is attached. The terms “vertical” and “vertically” refer to a direction perpendicular to the plane of the surface of the winding support portion to which the winding lamina is attached. It is noted that terms such as top, over, above, and under may be used in this disclosure. These terms should not be construed as limiting the position or orientation of a structure or element, but should be used to provide spatial relationship between structures or elements.

For the purposes of this disclosure, ferromagnetic material is a material having a relative magnetic permeability greater than 1,000. The relative magnetic permeability mat be estimated as a ratio of absolute magnetic permeability to the magnetic permeability of free space. Ferromagnetic materials include iron and iron alloys, and ferrite ceramics, by way of example. Ferromagnetic materials may be solid metal or ferrite ceramic, or may be aggregates of ferromagnetic particles.

It is to be noted that in the text as well as in all of the figures, the respective structures that are termed the “microelectronic device” will be referred to by a reference number, such as 100, 200, etc., Though the device is not yet a complete microelectronic device until some of the last stages of manufacturing described herein. Similarly, the respective structures that are termed the “magnetic component” will be referred to by a reference number, such as 110, 210, etc., Though the component is not yet a complete magnetic component until some of the last stages of manufacturing described herein. This is done primarily for the convenience of the reader.

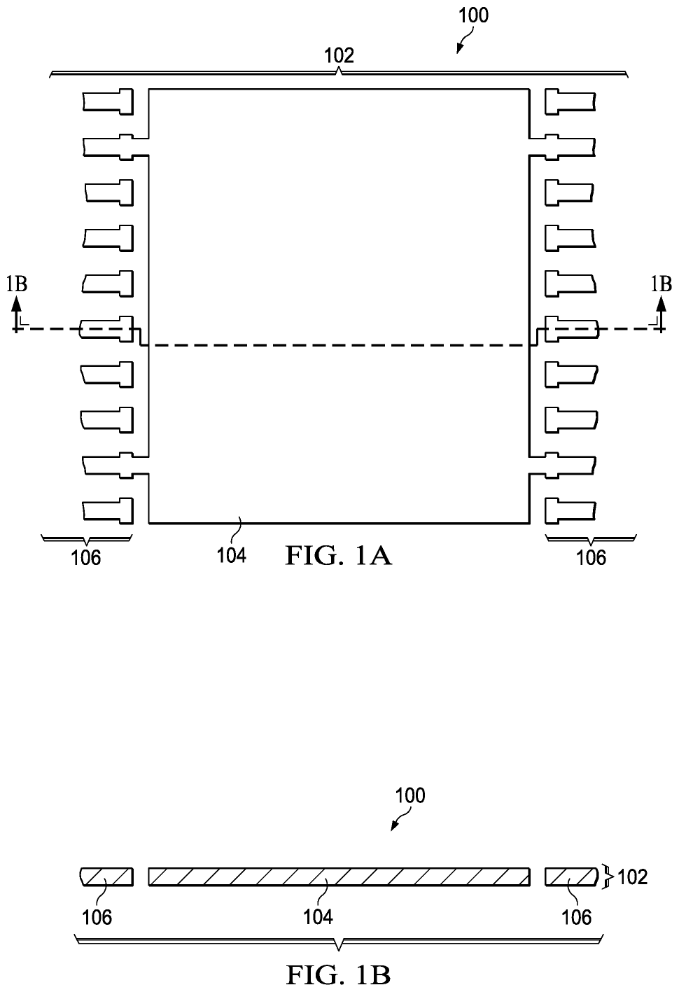

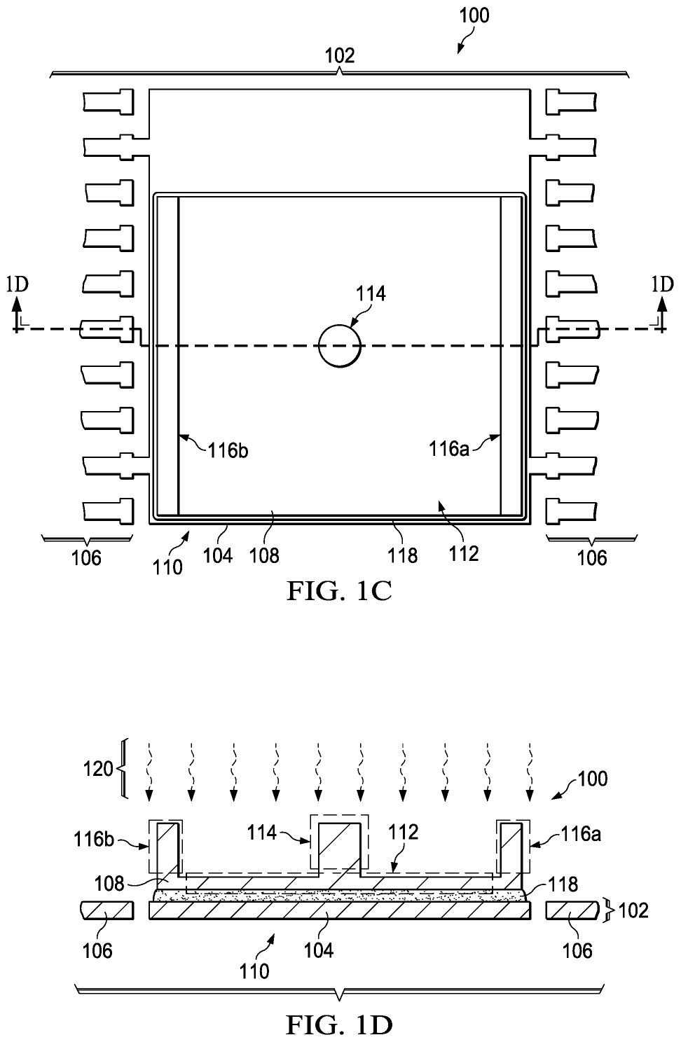

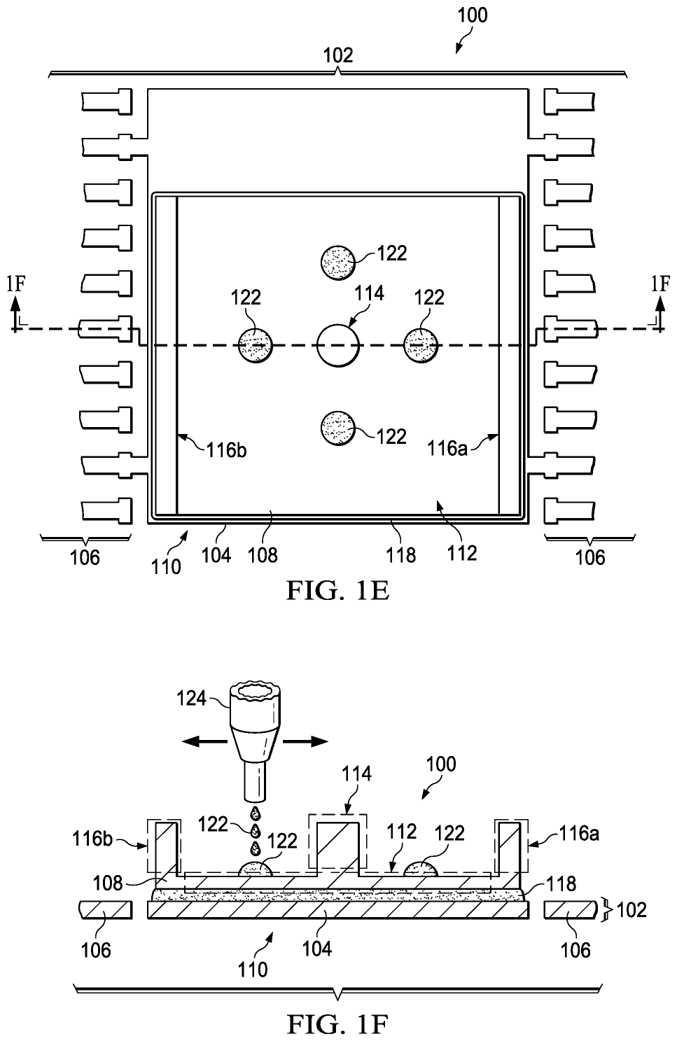

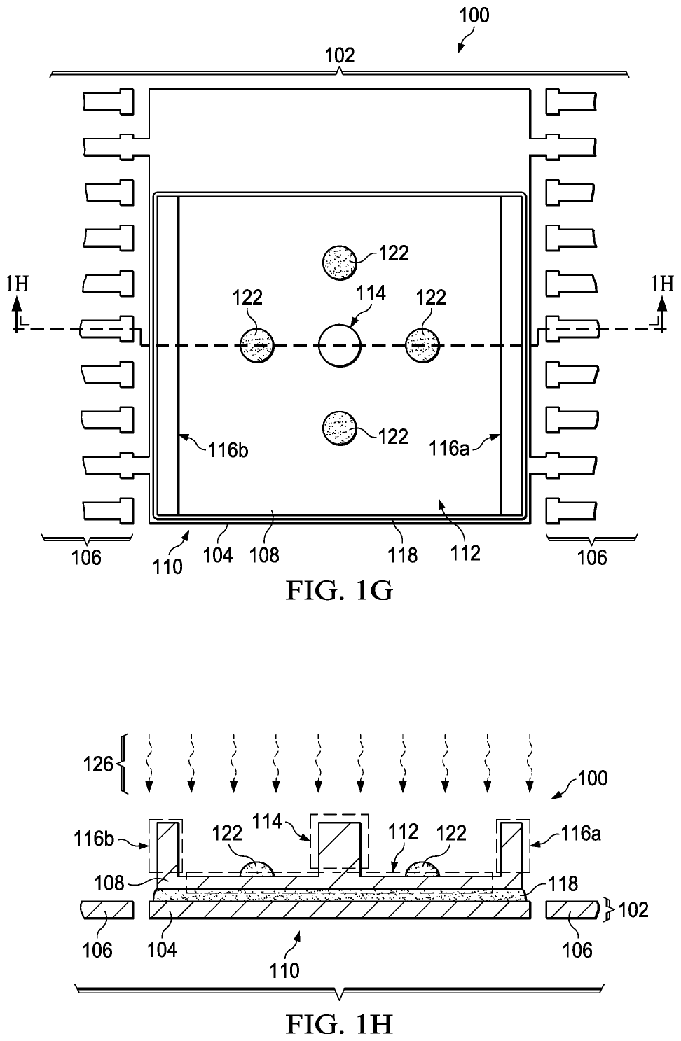

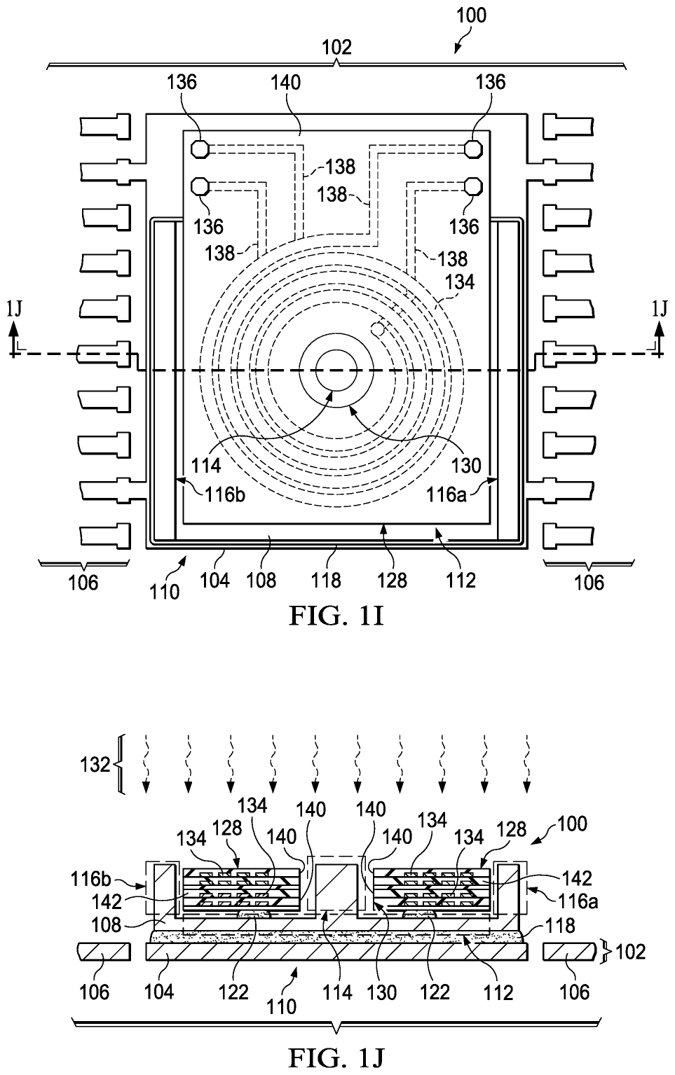

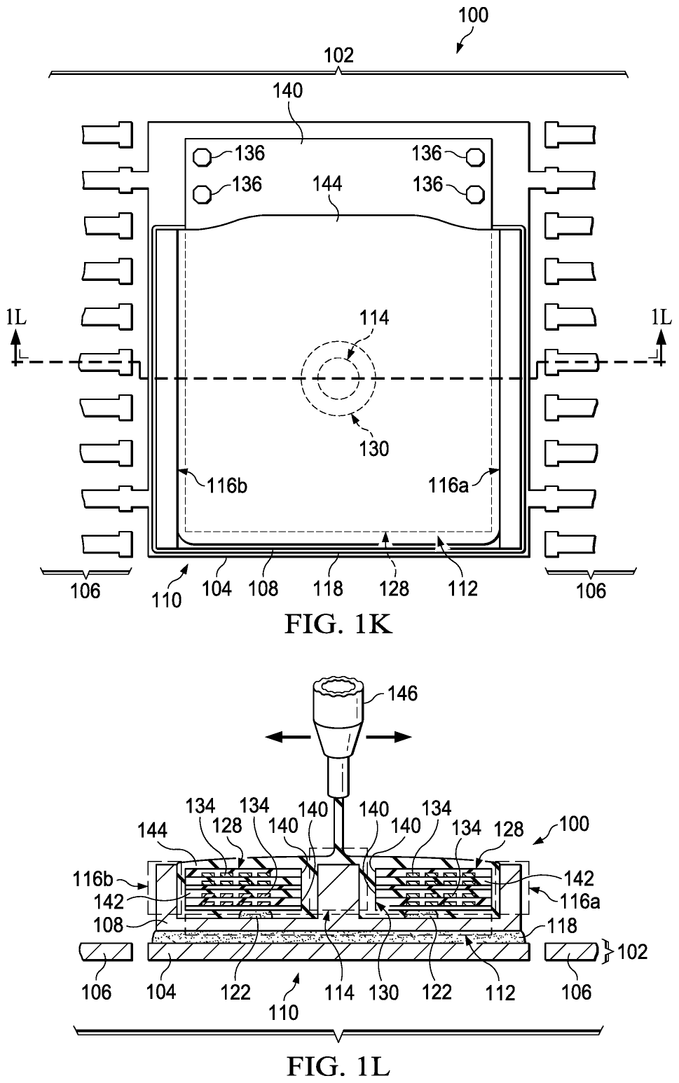

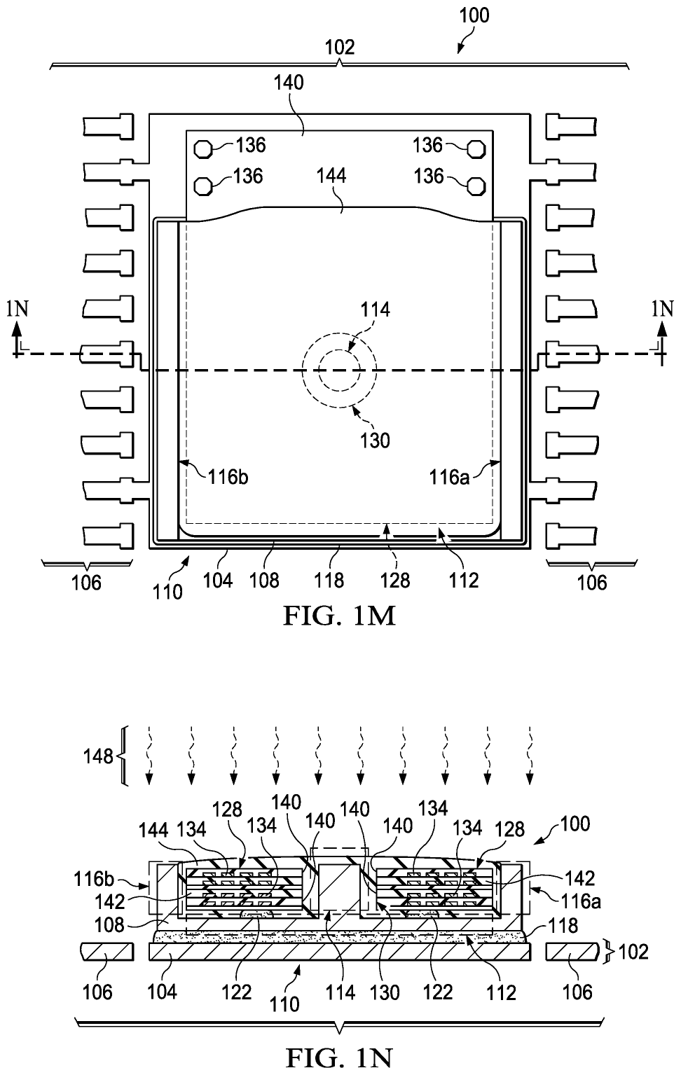

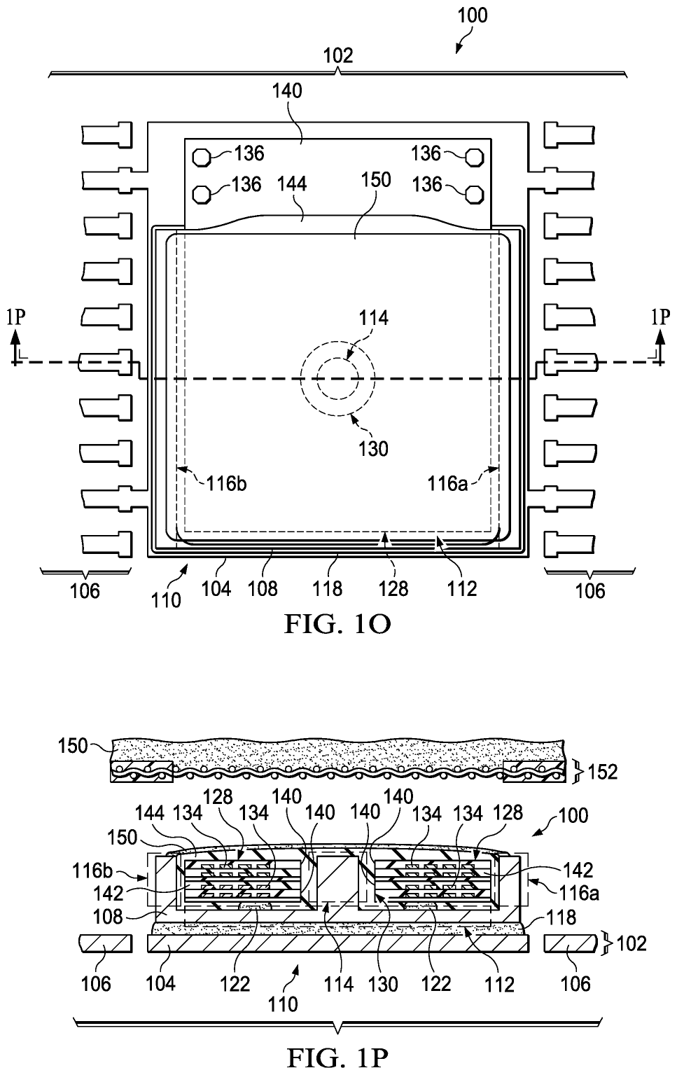

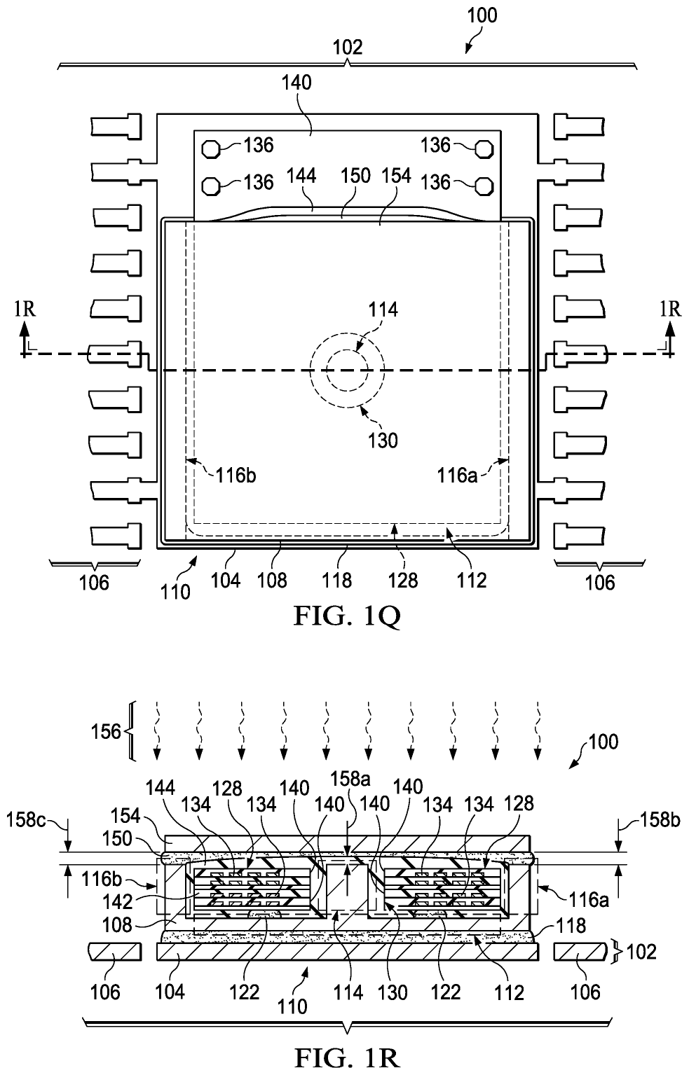

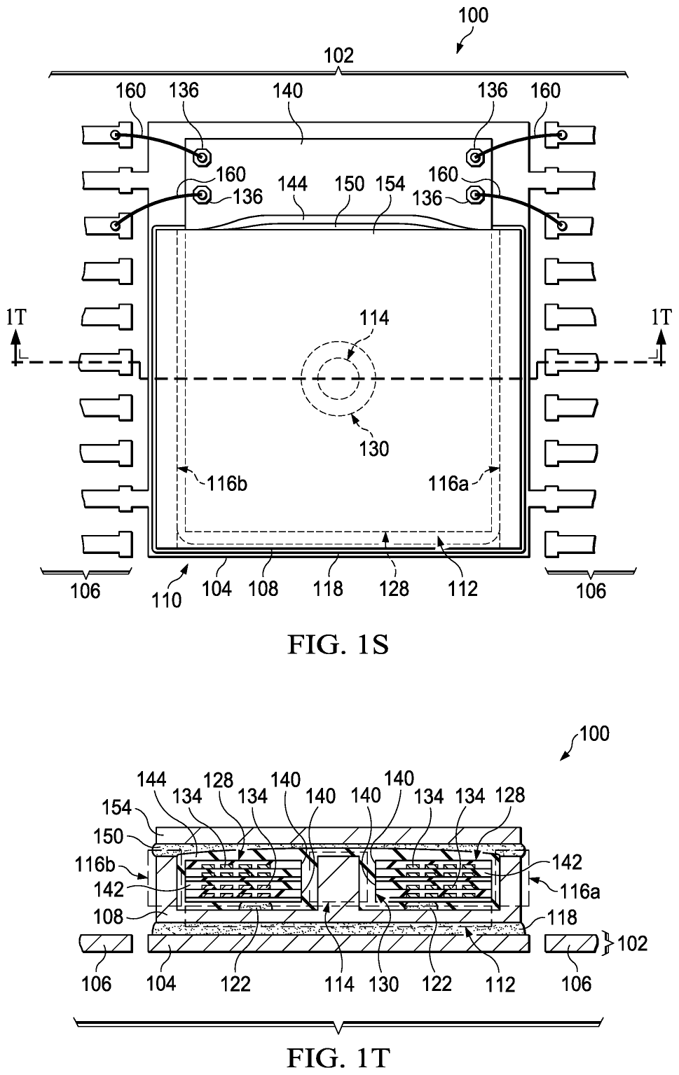

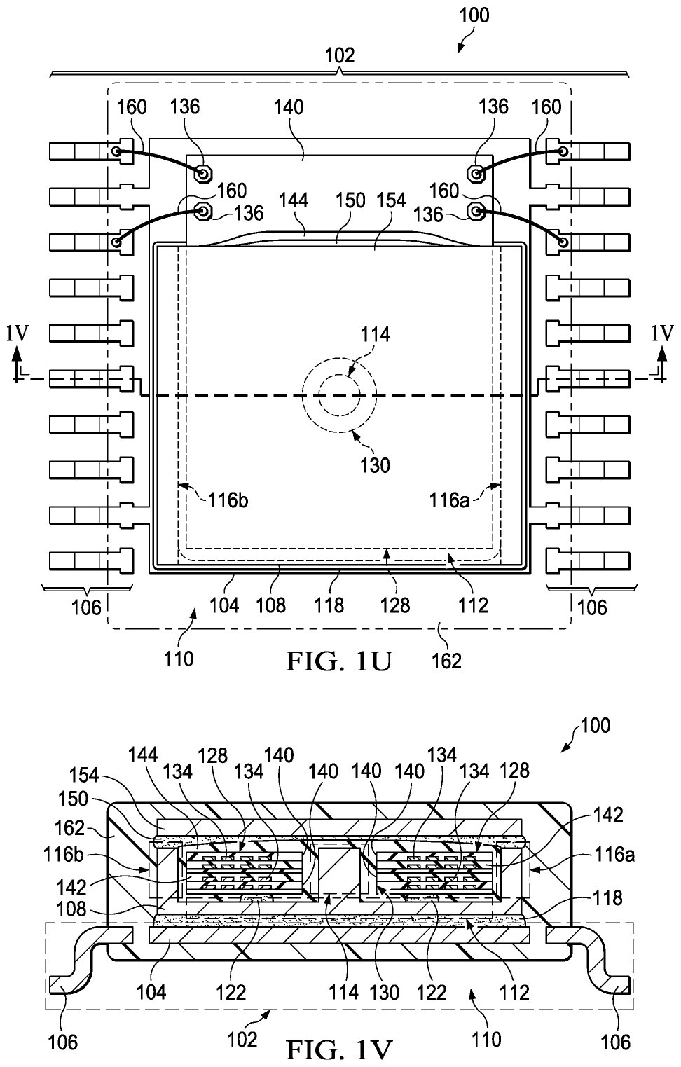

FIG. 1A through FIG. 1V are alternately top views and cross sections of an example microelectronic device including a magnetic component, depicted in successive stages of an example method of formation. Referring to FIG. 1A and FIG. 1B, the microelectronic device 100 of this example includes a lead frame 102. The lead frame 102 includes a die pad 104 and external leads 106. The die pad 104 may be connected to one or more of the external leads 106, as depicted in FIG. 1A. The lead frame 102 may include copper, stainless steel, or other metal. The lead frame 102 may be plated with one or more corrosion resistant metals, such as copper, nickel, or gold.

Referring to FIG. 1C and FIG. 1D, a first magnetic core segment 108 of the magnetic component 110 is attached to the die pad 104. The first magnetic core segment 108 includes a winding support portion 112. The winding support portion 112 includes ferromagnetic material. The first magnetic core segment 108 includes a center extension portion 114 which extends from the winding support portion 112. In this example, the center extension portion 114 may be located near a center of the winding support portion 112, as depicted in FIG. 1C and FIG. 1D. The center extension portion 114 also includes ferromagnetic material. In this example, the first magnetic core segment 108 also includes a first lateral extension portion 116a and a second lateral extension portion 116b, which extend from the winding support portion 112 at a lateral perimeter of the first magnetic core segment 108, as depicted in FIG. 1C and FIG. 1D. The lateral extension portions 116a and 116b include ferromagnetic material. The ferromagnetic material of the winding support portion 112, the ferromagnetic material of the center extension portion 114, and the ferromagnetic material of the lateral extension portions 116a and 116b may have similar compositions, that is, may be formed of the same ferromagnetic material. Alternately, the winding support portion 112, the center extension portion 114, and the lateral extension portions 116a and 116b may have different compositions of ferromagnetic material, depending on how the first magnetic core segment 108 is fabricated.

The first magnetic core segment 108 may be attached to the die pad 104 by a first adhesive material 118, such as a die attach adhesive. The first adhesive material 118 may be dispensed onto the die pad 104 by a continuous extrusion dispense process using a pneumatic pressurized needle, a continuous extrusion dispense process using an auger pressurized dispense process, a screen print process, or a stamping process, also referred to as a daubing process, by way of example. The first magnetic core segment 108 may be pressed onto the first adhesive material 118 to attain a desired bond thickness of the first adhesive material 118. The first adhesive material 118 may be heated in a first curing process 120 to cure the first adhesive material 118 and thus permanently bond the first magnetic core segment 108 to the die pad 104. The first curing process 120 may be implemented as a convection oven heating process, a radiant heating process, as indicated schematically in FIG. 1D, or a hotplate heating process, by way of example. Other implementations of processes for curing the first adhesive material 118 are within the scope of this example. In alternate versions of this example, the first magnetic core segment 108 may be attached to the die pad 104 by welding, by tape, or other method that does not use the first adhesive material 118.

Referring to FIG. 1E and FIG. 1F, a second adhesive material 122 is formed on the winding support portion 112. The second adhesive material 122 may be implemented as a die attach adhesive. The second adhesive material 122 is formed on the winding support portion 112 to have a thickness of at least than 25 microns, to provide sufficient space between the winding support portion 112 and a winding lamina 128, shown in FIG. 1I and FIG. 1J, of the magnetic component 110, so that a filler material 144, shown in FIG. 1K and FIG. 1L, can subsequently fill the space between the winding support portion 112 and a winding lamina 128. The second adhesive material 122 may have a viscosity of 20,000 centipoise to 300,000 centipoise, at a temperature of 20° C. to 25° C., and may have a surface tension of 35 dynes/cm to 60 dynes/cm, also at a temperature of 20° C. to 25° C., to control bleedout on the winding support portion 112. The second adhesive material 122 may include 20 volume percent to 50 volume percent of filler particles, such as flakes or rods of silicon dioxide, silicon nitride, boron nitride, or aluminum oxide, greater than 10 microns in size, to attain the desired thickness on the winding support portion 112 and further control bleedout. Having the filler particles in the shape of flakes or rods may advantageously provide the desired values for the viscosity and the surface tension with a lower volume fraction of the filler particles compared to a similar adhesive material using spherical filler particles. The viscosity of the second adhesive material 122 may be measured using a Brookfield viscometer using a CP-51 cone spinning at 5 rpm, at 25° C. The surface tension may be estimated by the droplet contact angle method, which measures a contact angle of a droplet of epoxy on a surface. The second adhesive material 122 may be implemented as a one part epoxy, for example. The second adhesive material 122 may have a same composition, or a similar composition, as the first adhesive material 118.

The second adhesive material 122 may be formed using a continuous extrusion dispense apparatus 124, as depicted in FIG. 1F. Alternatively, the second adhesive material 122 may be formed using a stamping process. Other processes for forming the second adhesive material 122 are within the scope of this example.

Referring to FIG. 1G and FIG. 1H, the second adhesive material 122 may optionally be partially cured, to reduce bleedout and provide a desired bond thickness when the winding lamina 128, shown in FIG. 1I and FIG. 1J, of the magnetic component 110, is attached to the winding support portion 112. The second adhesive material 122 may be partially cured by a second curing process 126 which heats the second adhesive material 122 to 70° C. to 100° C. in a vacuum for 10 minutes to 30 minutes. The second curing process 126 may be implemented as a convection oven heating process, a radiant heating process, as indicated schematically in FIG. 1H, a hotplate heating process, or an ultraviolet (UV) radiation process, by way of example. Other implementations of processes for partially curing the second adhesive material 122 are within the scope of this example. After the second curing process 126, the second adhesive material 122 is sufficiently pliable and adherent to attach the winding lamina 128. If the second adhesive material 122 has sufficiently low bleedout and sufficiently high viscosity after being formed, to provide the desired bond thickness, the second curing process 126 may be omitted.

Referring to FIG. 1I and FIG. 1J, the winding lamina 128 is attached to the winding support portion 112 by the second adhesive material 122. The winding lamina 128 has an aperture 130 to accommodate the center extension portion 114. The winding lamina 128 may be positioned over the second adhesive material 122 and pressed into the second adhesive material 122 to provide the desired bond thickness, that is, the desired distance between the winding lamina 128 and the winding support portion 112. The center extension portion 114 extends through the aperture 130. The aperture 130 is larger than the center extension portion 114, so that the winding lamina 128 is laterally separated from the center extension portion 114 around at least a portion of a lateral perimeter of the center extension portion 114.

The winding lamina 128 includes winding loops 134 of electrically conductive material. The winding loops 134 extend completely around the center extension portion 114, in this example. The winding lamina 128 includes connection pads 136 which are electrically coupled to the winding loops 134. The connection pads 136 may be electrically coupled to the winding loops 134 through electrically conductive wiring lines 138 in the winding lamina 128, for example. The winding loops 134 may be configured on more than one level, as depicted in FIG. 1J, separated by layers 140 of electrically insulating material 142 of the winding lamina 128. The electrically insulating material 142 may include polyester, epoxy, or polyimide, for example, and may be reinforced with fibers, not shown.

The second adhesive material 122 is cured to permanently bond the winding lamina 128 to the winding support portion 112. The second adhesive material 122 may be cured by a third curing process 132 which heats the second adhesive material 122 to 130° C. to 160° C. in a vacuum for 45 minutes to 12 minutes. The third curing process 132 may be implemented as a convection oven heating process, a radiant heating process, as indicated schematically in FIG. 1J, or a hotplate heating process, by way of example. Other implementations of processes for curing the second adhesive material 122 are within the scope of this example.

Referring to FIG. 1K and FIG. 1L, a filler material 144 is formed on the first magnetic core segment 108, between the first magnetic core segment 108 and the winding lamina 128. The filler material 144 contacts both the first magnetic core segment 108 and the winding lamina 128. The filler material 144 fills at least a portion of the space between the first magnetic core segment 108 and the winding lamina 128. The filler material 144 may be free of voids between the winding lamina 128 and the first magnetic core segment 108, which may advantageously improve reliability of the magnetic component 110 compared to a similar magnetic component having voids. The filler material 144 may be formed partially over the winding lamina 128, as depicted in FIG. 1K and FIG. 1L, leaving the connection pads 136 exposed to enable formation of electrical connections to the connection pads 136.

The filler material 144 may be implemented as a underfill adhesive. The filler material 144 may have a viscosity of 10,000 centipoise to 60,000 centipoise, at a temperature of 20° C. to 25° C., and may have a surface tension of 35 dynes/cm to 60 dynes/cm, also at a temperature of 20° C. to 25° C., to facilitate filling the space between the first magnetic core segment 108 and the winding lamina 128. The viscosity of the filler material 144 may be measured using a Brookfield viscometer, as disclosed in reference to measuring the viscosity of the second adhesive material 122. The surface tension may be estimated by a similar process as the second adhesive material 122. In one version of this example, the filler material 144 may be free of filler particles. In another version, the filler material 144 may include filler particles, such as spherical or rounded particles, less than 10 microns in size. The size of the filler particles is less than the space between the winding support portion 112 and the winding lamina 128, to facilitate filling the space between the first magnetic core segment 108 and the winding lamina 128. The filler material 144 may include the filler particles at a low volume density, for example, less than 20 volume percent, to maintain the viscosity sufficiently low to enable filling the space between the first magnetic core segment 108 and the winding lamina 128. The second adhesive material 122 may have a higher volume percent of filler particles than the filler material 144. Spherical or rounded particles may advantageously provide lower viscosity compared to flakes or rods. The filler material 144 may be implemented as a one part epoxy, for example.

The filler material 144 may be formed on the first magnetic core segment 108 using a continuous extrusion dispensing apparatus 146, for example. Alternatively, the filler material 144 may be formed using an inkjet apparatus. Other methods and equipment for forming the filler material 144 are within the scope of this example.

Referring to FIG. 1M and FIG. 1N, the filler material 144 is cured, converting the filler material 144 to a solid in the space between the first magnetic core segment 108 and the winding lamina 128. After the filler material 144 is cured, the filler material 144 between the first magnetic core segment 108 and the winding lamina 128 may be free of voids, which may advantageously improve reliability of the magnetic component 110. The filler material 144 may be cured by a fourth curing process 148 which heats the filler material 144 to 130° C. to 160° C. in a vacuum for 45 minutes to 120 minutes. The fourth curing process 148 may be implemented as a convection oven heating process, a radiant heating process, as indicated schematically in FIG. 1N, or a hotplate heating process, by way of example. Other implementations of processes for curing the filler material 144 are within the scope of this example.

Referring to FIG. 1O and FIG. 1P, a third adhesive material 150 is formed over the first magnetic core segment 108, and optionally over the winding lamina 128 and the filler material 144. The third adhesive material 150 may be formed in a continuous layer, extending across the winding lamina 128 and the filler material 144, and over the lateral extension portions 116a and 116b of the first magnetic core segment 108, as depicted in FIG. 1O and FIG. 1P. The third adhesive material 150 may have a same composition, or a similar composition, as the first adhesive material 118 or the second adhesive material 122.

The third adhesive material 150 may be formed using a screen printing apparatus 152, as depicted in FIG. 1P. Alternatively, the third adhesive material 150 may be formed using a continuous extrusion dispensing apparatus. Other methods and apparatus for forming the third adhesive material 150 are within the scope of this example.

Referring to FIG. 1Q and FIG. 1R, a second magnetic core segment 154 is placed on the third adhesive material 150. The second magnetic core segment 154 includes ferromagnetic material that extends over the lateral extension portions 116a and 116b, the winding lamina 128, and the center extension portion 114. The second magnetic core segment 154 may have a same composition, or a similar composition, as the first magnetic core segment 108. The second magnetic core segment 154 may be pressed down on the third adhesive material 150 to reduce a separation between the second magnetic core segment 154 and the center extension portion 114 and the lateral extension portions 116a and 116b of the first magnetic core segment 108, and to remove any voids under the second magnetic core segment 154. In some cases, the third adhesive material 150 may be squeezed out of regions between the second magnetic core segment 154 and the filler material 144.

The third adhesive material 150 is subsequently cured to permanently bond the second magnetic core segment 154 to the first magnetic core segment 108. The third adhesive material 150 may be cured by a fifth curing process 156 with a thermal profile similar to the third curing process 132 of FIG. 1I and FIG. 1J. The fifth curing process 156 may be implemented as a convection oven heating process, a radiant heating process, as indicated schematically in FIG. 1R, or a hotplate heating process, by way of example. Other implementations of processes for curing the third adhesive material 150 are within the scope of this example.

After the third adhesive material 150 is cured, the third adhesive material 150 between the first magnetic core segment 108 and the second magnetic core segment 154 may be free of voids, which may advantageously improve reliability of the magnetic component 110. A first separation 158a between the second magnetic core segment 154 and the center extension portion 114, a second separation 158b between the second magnetic core segment 154 and the first lateral extension portion 116a, and a third separation 158c between the second magnetic core segment 154 and the second lateral extension portion 116b may each be less than 100 microns, which may contribute to providing a low magnetic reluctance path around the winding loops 134 through the center extension portion 114, the winding support portion 112, and the lateral extension portions 116a and 116b of the first magnetic core segment 108 and the second magnetic core segment 154, that is, a path with a magnetic reluctance at least 100 times lower than a comparable path of air or other nonmagnetic material.

Referring to FIG. 1S and FIG. 1T, electrical connections 160 are formed between the connection pads 136 and two or more of the external leads 106, thus forming electrical connections between the winding loops 134 and the external leads 106. The electrical connections 160 may be implemented as wire bonds, as depicted in FIG. 1S, of gold wire, copper wire, or aluminum wire, and may be formed by wire bonding process. The electrical connections 160 may be implemented as ribbon bonds of gold ribbon, copper ribbon, or aluminum ribbon, and may be formed by a ribbon wedge bonding process or a micro-welding process. The electrical connections 160 may be implemented as flat conductors of gold or copper, and may be formed by a tape automated bonding (TAB) process. In other versions of this example, the electrical connections 160 may be implemented as solder bump bonds or soldered clip connections.

The winding lamina 128 with the winding loops 134, the first magnetic core segment 108, the second magnetic core segment 154, the electrical connections 160, and the external leads 106 connected to the electrical connections 160 provide the magnetic component 110. The center extension portion 114, the winding support portion 112, and the lateral extension portions 116a and 116b of the first magnetic core segment 108, and the second magnetic core segment 154 provide the low magnetic reluctance path around the winding loops 134, that is, a path with a magnetic reluctance at least 100 times lower than a comparable path of air or other nonmagnetic material.

In one version of this example, the magnetic component 110 may be manifested as an isolation transformer, in which the winding loops 134 include a primary winding and a secondary winding, having equal numbers of loops. In another version of this example, the magnetic component 110 may be manifested as a step-up transformer, in which the winding loops 134 include a primary winding and a secondary winding, with the secondary winding having more loops than the primary winding. In a further version of this example, the magnetic component 110 may be manifested as a step-down transformer, in which the winding loops 134 include a primary winding and a secondary winding, with the secondary winding having less loops than the primary winding. In another version of this example, the magnetic component 110 may be manifested as an inductor, in which the winding loops 134 include only one winding. Other manifestations of the magnetic component 110 are within the scope of this example.

Referring to FIG. 1U and FIG. 1V, a package material 162 of the microelectronic device 100 is formed on the magnetic component 110, the die pad 104, and portions of the external leads 106. The package material 162 is electrically non-conductive. The package material 162 may be manifested as an encapsulation material, a molding compound, or a potting compound, as examples. The package material 162 may include epoxy, and may optionally include particles of inorganic material to reduce a thermal expansion coefficient of the package material 162. The package material 162 may be formed in this example by an injection mold process or a reaction injection molding (RIM) process, for example. The package material 162 may fill any gaps between the winding lamina 128, the first magnetic core segment 108, and the second magnetic core segment 154 that are not filled by the filler material 144 or the third adhesive material 150.

The external leads 106 are severed from the lead frame 102 to singulate the microelectronic device 100. The external leads 106 may be bent or shaped to provide a desired lead configuration, as depicted in FIG. 1U and FIG. 1V. The microelectronic device 100 of this example is depicted as a small outline package, but may be manifested as having another package type. In an alternate version of this example, the microelectronic device 100 may include additional components, such as semiconductor devices, such as transistors and diodes, or passive components, such as resistors and capacitors, encapsulated by the package material 162.

The microelectronic device 100 of this example may advantageously enable a lower cost of fabrication by having the single winding lamina 128. In versions of this example in which the magnetic component 110 is manifested as a transformer in which the winding loops 134 include a primary winding and a secondary winding, having the winding loops 134 in the single winding lamina 128 may reduce fabrication cost and complexity compared to a similar microelectronic device having a primary winding in one winding lamina and a secondary winding in another winding lamina.

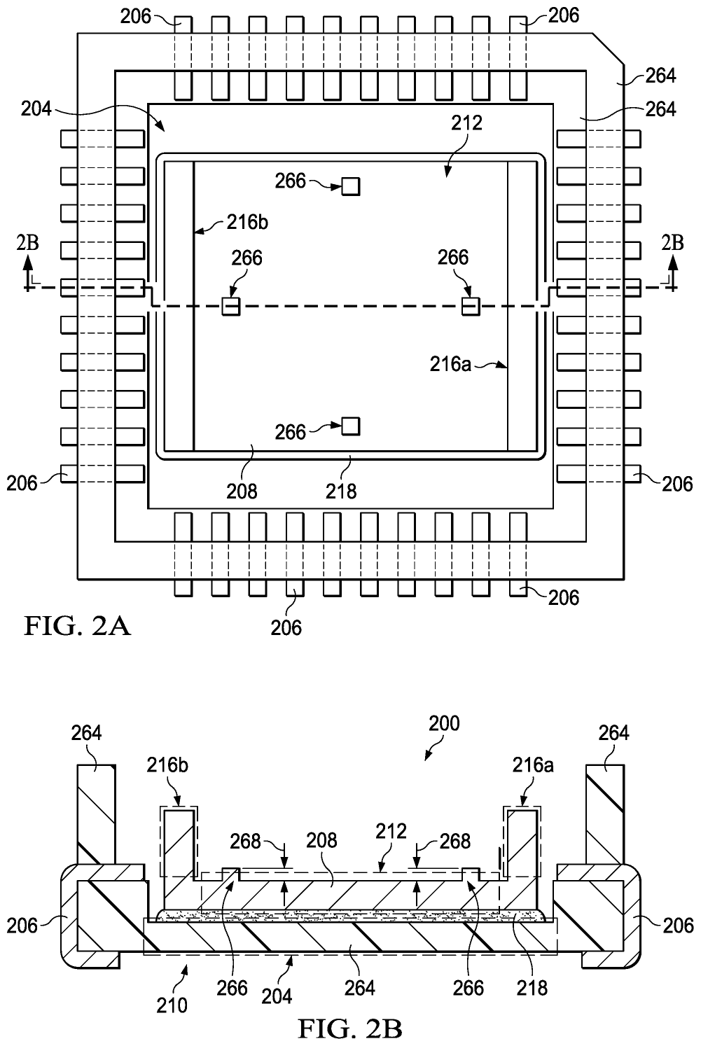

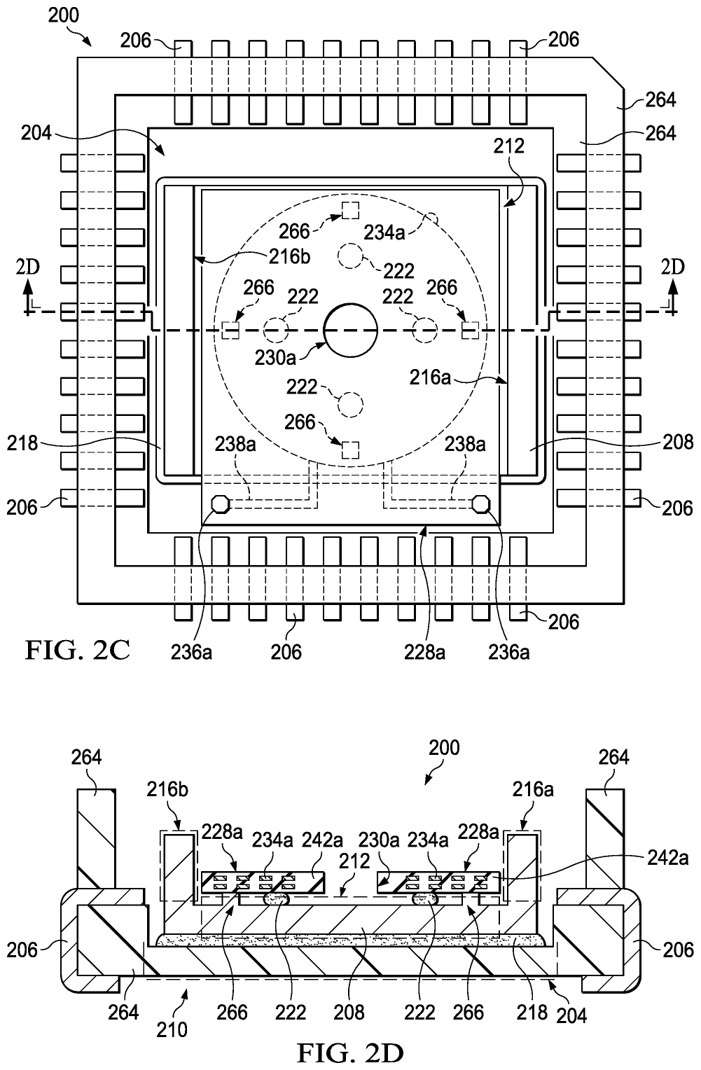

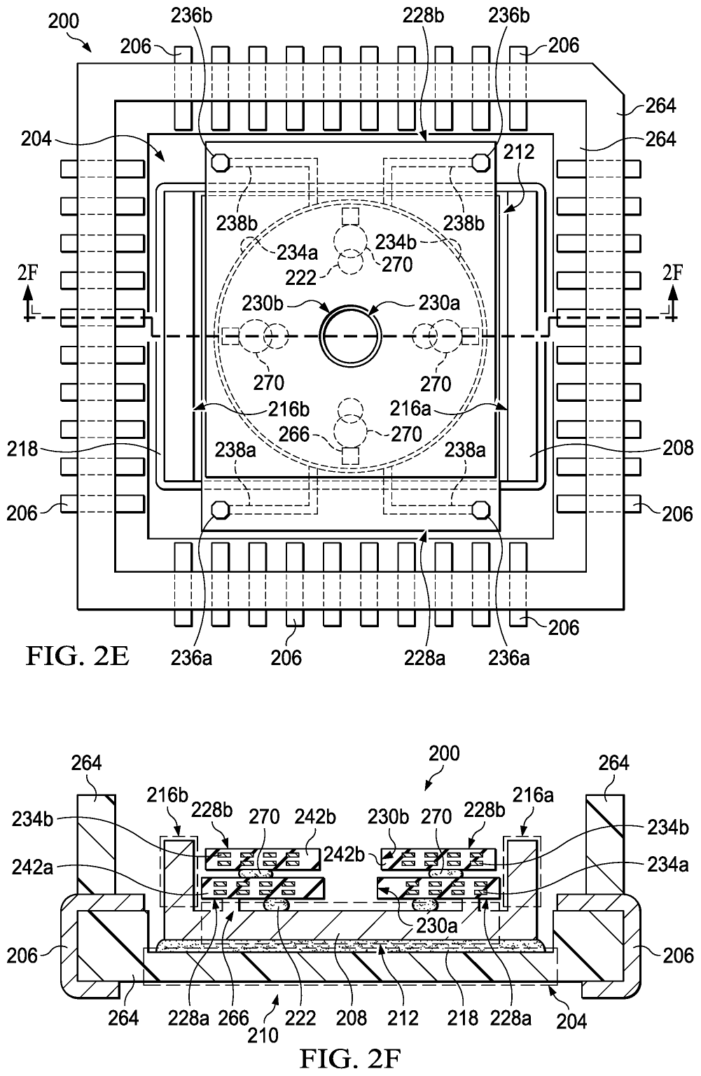

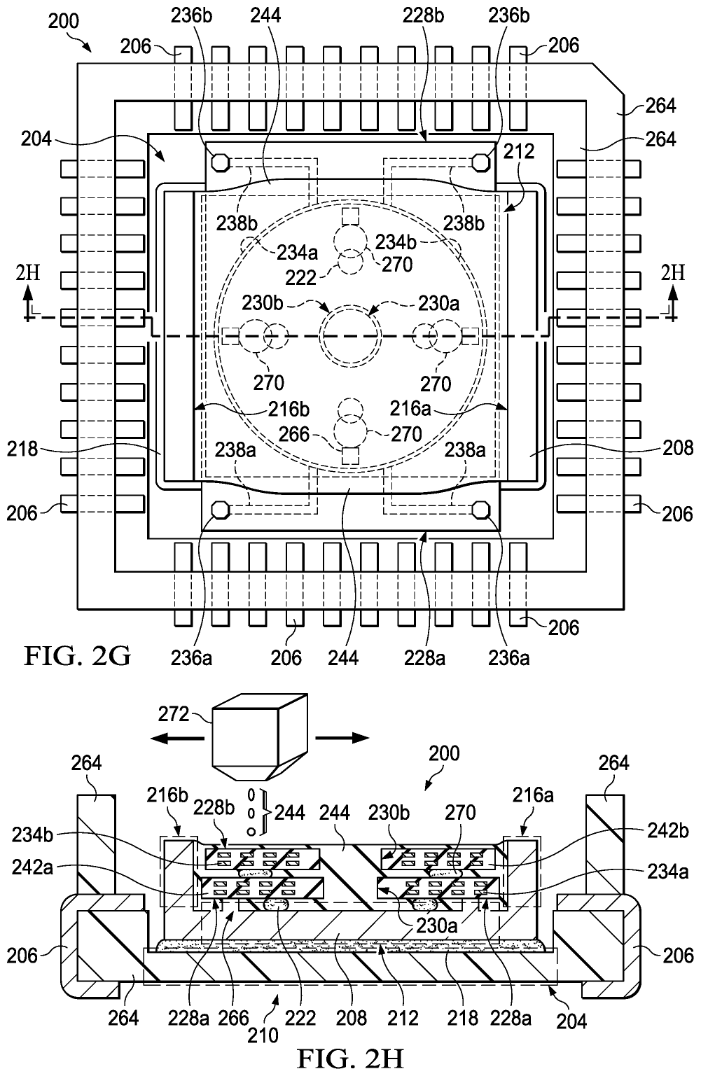

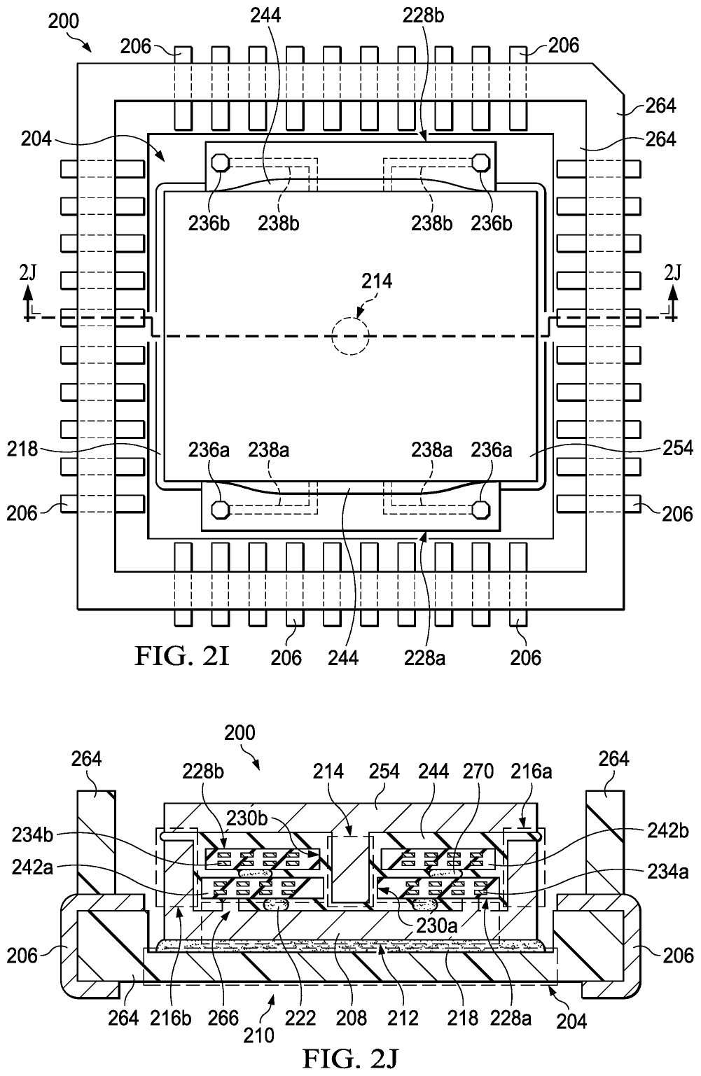

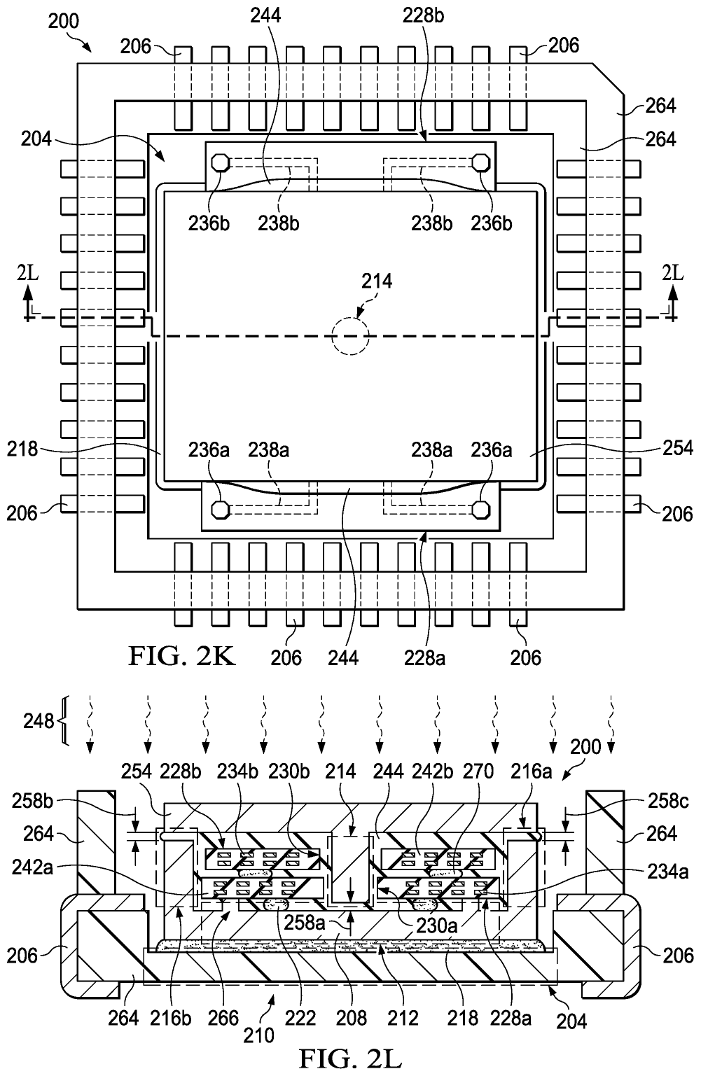

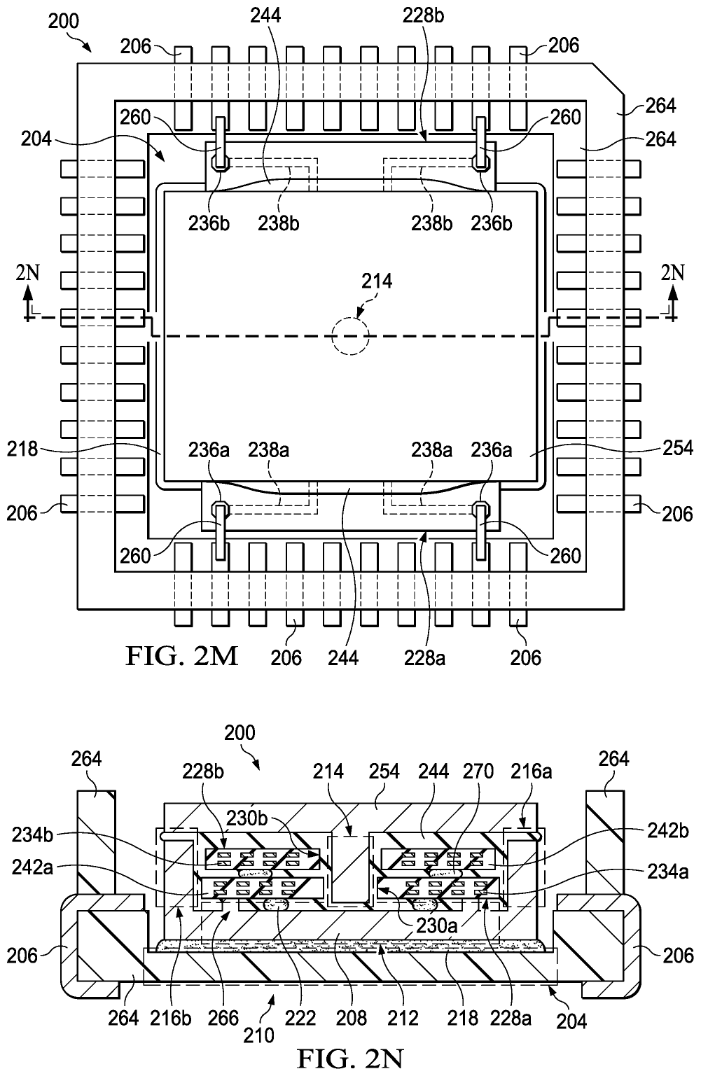

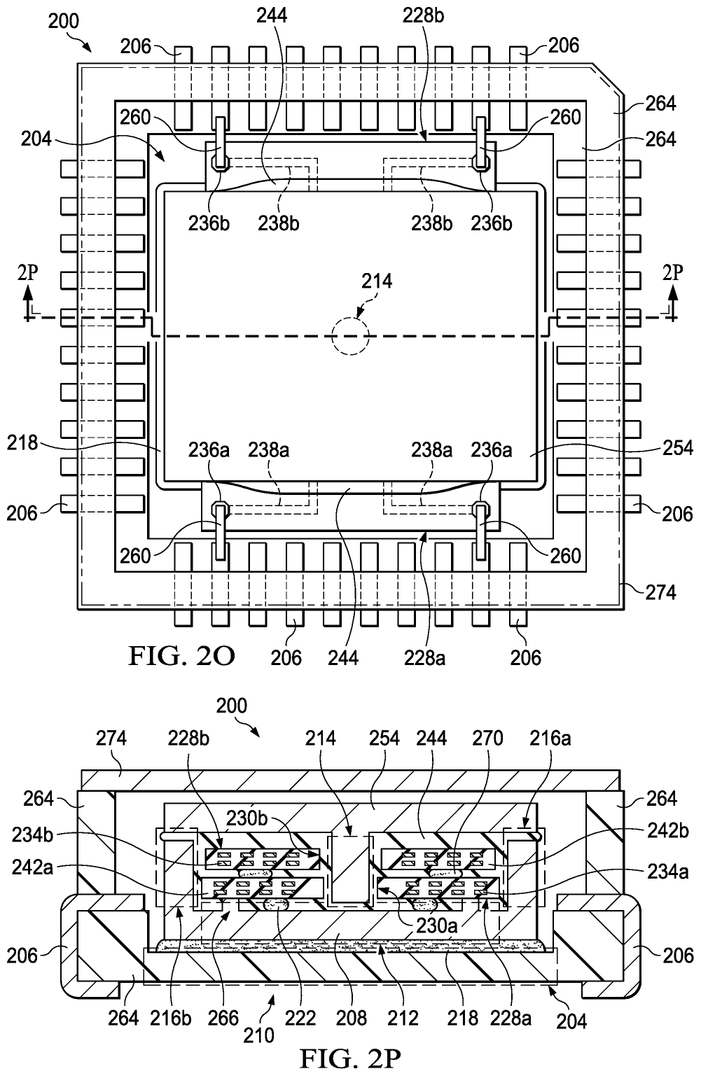

FIG. 2A through FIG. 2P are alternately top views and cross sections of another example microelectronic device including a magnetic component, depicted in successive stages of another example method of formation. Referring to FIG. 2A and FIG. 2B, the microelectronic device 200 of this example includes a chip carrier 264. The chip carrier 264 may include ceramic, plastic, or other electrically non-conductive material providing a structural base. The chip carrier 264 includes external leads 206. The external leads 206 may include copper, stainless steel, or other metal, and may be plated with one or more corrosion resistant metals, such as copper, nickel, or gold. The chip carrier 264 may include a die pad 204 between the external leads 206. The die pad 204 may have the ceramic, plastic, or other electrically non-conductive material, as indicated in FIG. 2B, and thus be electrically non-conductive, or may have a metal plate and thus be electrically conductive.

A first magnetic core segment 208 of the magnetic component 210 is attached to the chip carrier 264. The first magnetic core segment 208 includes a winding support portion 212 that includes ferromagnetic material. The first magnetic core segment 208 also includes a first lateral extension portion 216a which extends from the winding support portion 212 at a lateral perimeter of the first magnetic core segment 208, and a second lateral extension portion 216b which extends from the winding support portion 212 at the lateral perimeter of the first magnetic core segment 208. In this example, the second lateral extension portion 216b is located opposite from the first lateral extension portion 216a, with the winding support portion 212 between the first lateral extension portion 216a and the second lateral extension portion 216b. The first lateral extension portion 216a and the second lateral extension portion 216b both include ferromagnetic material. The ferromagnetic material of the winding support portion 212, the ferromagnetic material of the first extension portion 216a, and the ferromagnetic material of the second extension portion 216b may have similar compositions, or alternatively, may alternatively have different compositions. In an alternate version of this example, the first magnetic core segment 208 may include a third lateral extension portion, not shown, at the lateral perimeter of the first magnetic core segment 208.

The first magnetic core segment 208 may include standoffs 266 extending from the winding support portion 212. The standoffs 266 may have a height 268 above the winding support portion 212 of 25 microns to 500 microns, to set a desired separation between the winding support portion 212 and a first winding lamina 228a, shown in FIG. 2C and FIG. 2D, so that a filler material 244, shown in FIG. 2G and FIG. 2H, can subsequently fill the space between the winding support portion 212 and the first winding lamina 228a. The standoffs 266 may optionally include ferromagnetic material; for example, the standoffs 266 may have a same composition as the winding support portion 212. Alternatively, the standoffs 266 may be free of ferromagnetic material, and may be formed by attaching pieces of non-magnetic material to the winding support portion 212.

The first magnetic core segment 208 may be attached to the chip carrier 264 using a first adhesive material 218. The first adhesive material 218 may be implemented as a die attach adhesive, and may be used to attach the first magnetic core segment 208 to the chip carrier 264 as disclosed in reference to FIG. 1C and FIG. 1D.

Referring to FIG. 2C and FIG. 2D, a second adhesive material 222 is formed on the winding support portion 212. The second adhesive material 222 may be implemented as a die attach adhesive, and may have the properties, such as viscosity and surface tension, disclosed in reference to the second adhesive material 122 of FIG. 1E and FIG. 1F. The second adhesive material 222 may have a same composition, or a similar composition, as the first adhesive material 218. The second adhesive material 222 may be formed on the winding support portion 212 using a continuous extrusion dispensing process, a stamping process, or other process. In one version of this example, the second adhesive material 222 may be formed in separate dots, as depicted in FIG. 2C and FIG. 2D, leaving a majority of the winding support portion 212 exposed. In another version, the second adhesive material 222 may be formed to cover a majority, or all, of the winding support portion 212.

The first winding lamina 228a is attached to the winding support portion 212 by the second adhesive material 222. The first winding lamina 228a has a first aperture 230a to accommodate a center extension portion 214 of a second magnetic core segment 208, shown in FIG. 2I and FIG. 2J. The first winding lamina 228a may be positioned over the second adhesive material 222 and pressed into the second adhesive material 222 until the first winding lamina 228a contacts the standoffs 266, to set the desired separation between the winding support portion 212 and the first winding lamina 228a. The second adhesive material 222 is cured to permanently bond the first winding lamina 228a to the winding support portion 212. The second adhesive material 222 may be cured as disclosed in reference to second adhesive material 122 of FIG. 1J.

The first winding lamina 228a includes first winding loops 234a of electrically conductive material in a first electrically insulating material 242a. The first winding loops 234a extend completely around the first aperture 230a. The first winding loops 234a are indicated by a lateral perimeter of the first winding loops 234a in FIG. 2C. The first winding lamina 228a includes first connection pads 236a which are electrically coupled to the first winding loops 234a. The first connection pads 236a may be electrically coupled to the first winding loops 234a through electrically conductive first wiring lines 238a in the first winding lamina 228a, for example. The first winding loops 234a may be configured on more than one level, as depicted in FIG. 2D, separated by first layers, not shown, of the first electrically insulating material 242a.

Referring to FIG. 2E and FIG. 2F, a third adhesive material 270 is formed on the first winding lamina 228a. The third adhesive material 270 may be identical to the second adhesive material 222. The third adhesive material 270 may be formed on the first winding lamina 228a using a similar process as used to form the second adhesive material 222. The third adhesive material 270 may optionally be partially cured, as disclosed in reference to the second adhesive material 122 of FIG. 1H, to set a desired separation between the first winding lamina 228a and a second winding lamina 228b.

The second winding lamina 228b is attached to the first winding lamina 228a by the third adhesive material 270. The second winding lamina 228b has a second aperture 230b to accommodate the center extension portion 214 of the second magnetic core segment 208, shown in FIG. 2I and FIG. 2J. The third adhesive material 270 is cured to permanently bond the second winding lamina 228b to the first winding lamina 228a. The third adhesive material 270 may be cured with a thermal profile similar to that used to cure the second adhesive material 122 of FIG. 1E and FIG. 1F, optionally including partially curing the third adhesive material 270 as disclosed in reference to FIG. 1G and FIG. 1H, to obtain a desired spacing between the second winding lamina 228b and the first winding lamina 228a. Alternatively, the first winding lamina 228a may have standoffs to provide the desired spacing.

The second winding lamina 228b includes second winding loops 234b of electrically conductive material in a second electrically insulating material 242b. The second winding loops 234b extend completely around the second aperture 230b. The second winding loops 234b are indicated by a lateral perimeter of the second winding loops 234b in FIG. 2E. The second winding lamina 228b includes second connection pads 236b which are electrically coupled to the second winding loops 234b, through electrically conductive second wiring lines 238b in the second winding lamina 228b, for example. The second winding loops 234b may be configured on more than one level, as depicted in FIG. 2F, separated by second layers, not shown, of the second electrically insulating material 242b.

In one version of this example, in which the magnetic component 210 is manifested as a transformer, the first winding loops 234a may provide a primary winding of the transformer, and the second winding loops 234b may provide a primary winding of the transformer. The transformer may be a step-up transformer, in which the second winding loops 234b have a greater number of loops, also referred to as turns, than the first winding loops 234a. The transformer may be a step-down transformer, in which the second winding loops 234b have a lesser number of turns than the first winding loops 234a. The transformer may be an isolation transformer, in which the second winding loops 234b and the first winding loops 234a have equal numbers of turns.

Referring to FIG. 2G and FIG. 2H, a filler material 244 is formed on the first magnetic core segment 208, the first winding lamina 228a, and the second winding lamina 228b, filling at least a portion of spaces between the first magnetic core segment 208, the first winding lamina 228a, and the second winding lamina 228b. The filler material 244 contacts the first magnetic core segment 208, the first winding lamina 228a, and the second winding lamina 228b. In this example, the filler material 244 may extend over the second winding lamina 228b, as depicted in FIG. 2G and FIG. 2H. The filler material 244 may be free of voids between the first magnetic core segment 208, the first winding lamina 228a, and the second winding lamina 228b, which may advantageously improve reliability of the magnetic component 210 compared to a similar magnetic component having voids. The filler material 244 may be formed partially over the second winding lamina 228b, as depicted in FIG. 2G and FIG. 2H, leaving the first connection pads 236a and the second connection pads 236b exposed to enable formation of electrical connections to the first connection pads 236a and the second connection pads 236b.

The filler material 244 may be implemented as a underfill adhesive, with the properties disclosed in reference to the filler material 144 of FIG. 1K and FIG. 1L. The filler material 244 may be formed on the first magnetic core segment 208 using a droplet dispensing apparatus 272, for example. Alternatively, the filler material 244 may be formed on the first magnetic core segment 208 using a continuous extrusion dispensing apparatus or other methods and equipment.

Referring to FIG. 2I and FIG. 2J, a second magnetic core segment 254 is attached to the first magnetic core segment 208 and the second winding lamina 228b. The second magnetic core segment 254 includes ferromagnetic material that extends over the lateral extension portions 216a and 216b, and the second winding lamina 228b. The second magnetic core segment 254 may have a same composition, or a similar composition, as the first magnetic core segment 208. The second magnetic core segment 254 of this example includes a center extension portion 214. The second magnetic core segment 254 is pressed onto the filler material 244, so that the center extension portion 214 extends through the first aperture 230a and through the second aperture 230b. The filler material 244 fills a space between the second magnetic core segment 254 and the first winding lamina 228a, and at least partially fills spaces between the second magnetic core segment 254 and the first lateral extension portion 216a, and between the second magnetic core segment 254 and the second lateral extension portion 216b. Elements of the first magnetic core segment 208, the first winding lamina 228a, and the second winding lamina 228b which are hidden by the second magnetic core segment 254 in FIG. 2I are not shown, to show more clearly the positions of the second magnetic core segment 254 and the center extension portion 214.

Referring to FIG. 2K and FIG. 2L, the filler material 244 is cured, converting the filler material 244 to a solid in the spaces between the first magnetic core segment 208, the first winding lamina 228a, and the second winding lamina 228b. After the filler material 244 is cured, the filler material 244 between the first magnetic core segment 208, the first winding lamina 228a, and the second winding lamina 228b may be free of voids, which may advantageously improve reliability of the magnetic component 210. The filler material 244 may be cured by a curing process 248. The curing process 248 may have a thermal profile similar to the fourth curing process 148 disclosed in reference to FIG. 1M and FIG. 1N. The curing process 248 may be implemented as a convection oven heating process, a radiant heating process, as indicated schematically in FIG. 2L, or a hotplate heating process, by way of example. Other implementations of processes for curing the filler material 244 are within the scope of this example.

A first separation 258a between the center extension portion 214 of the second magnetic core segment 254 and the winding support portion 212 of the first magnetic core segment 208, a second separation 258b between the second magnetic core segment 254 and the first lateral extension portion 216a, and a third separation 258c between the second magnetic core segment 254 and the second lateral extension portion 216b may each be less than 100 microns, which may contribute to providing a low magnetic reluctance path, that is, a path with a magnetic reluctance at least 100 times lower than a comparable path of air or other nonmagnetic material, around the winding loops 234a and 234b through the winding support portion 212 and the lateral extension portions 216a and 216b of the first magnetic core segment 208 and the center extension portion 214 of the second magnetic core segment 254.

Referring to FIG. 2M and FIG. 2N, electrical connections 260 are formed between the connection pads 236a and 236b and four or more of the external leads 206, thus forming electrical connections between the winding loops 234a and 234b and the external leads 206. The electrical connections 260 may be implemented as tape automated bonds, as depicted in FIG. 2M, of gold ribbon, copper ribbon, or aluminum ribbon, and may be formed by TAB process. The electrical connections 260 may be implemented as ribbon bonds, and may be formed by a ribbon wedge bonding process or a micro-welding process. The electrical connections 260 may be implemented as wire bonds, and may be formed by a wire bonding process. In other versions of this example, the electrical connections 260 may be implemented as solder bump bonds or soldered clip connections.

The first winding lamina 228a with the first winding loops 234a, the second winding lamina 228b with the second winding loops 234b, the first magnetic core segment 208, the second magnetic core segment 254, the electrical connections 260, and the external leads 206 connected to the electrical connections 260 provide the magnetic component 210. The winding support portion 212 and the lateral extension portions 216a and 216b of the first magnetic core segment 208, and the second magnetic core segment 254 with the center extension portion 214 provide the low magnetic reluctance path around the winding loops 234a and 234b, that is, a path with a magnetic reluctance at least 100 times lower than a comparable path of air or other nonmagnetic material.

Referring to FIG. 2O and FIG. 2P, a package lid 274 is attached to the chip carrier 264, enclosing the magnetic component 210. The package lid 274 may include metal, ceramic, plastic, or other material. The package lid 274 may be attached to the chip carrier 264 by an adhesive process, by a soldering process, by a welding process, or by a glass frit bonding process, by way of example.

The microelectronic device 200 of this example may advantageously enable flexibility of fabrication by having the first winding lamina 228a separate from the second winding lamina 228b. In versions of this example in which the magnetic component 210 is manifested as a transformer in which the first winding loops 234a include a primary winding and the second winding loops 234b include a secondary winding, having the winding loops 234a and 234b in separate winding lamina 228a and 228b may enable selecting desired values of turns for the primary winding and the secondary winding from a smaller inventory of winding lamina compared to having a single winding lamina with both primary winding and secondary winding, which would require a larger inventory of winding laminae with all needed combinations of turns for the primary winding and the secondary winding.

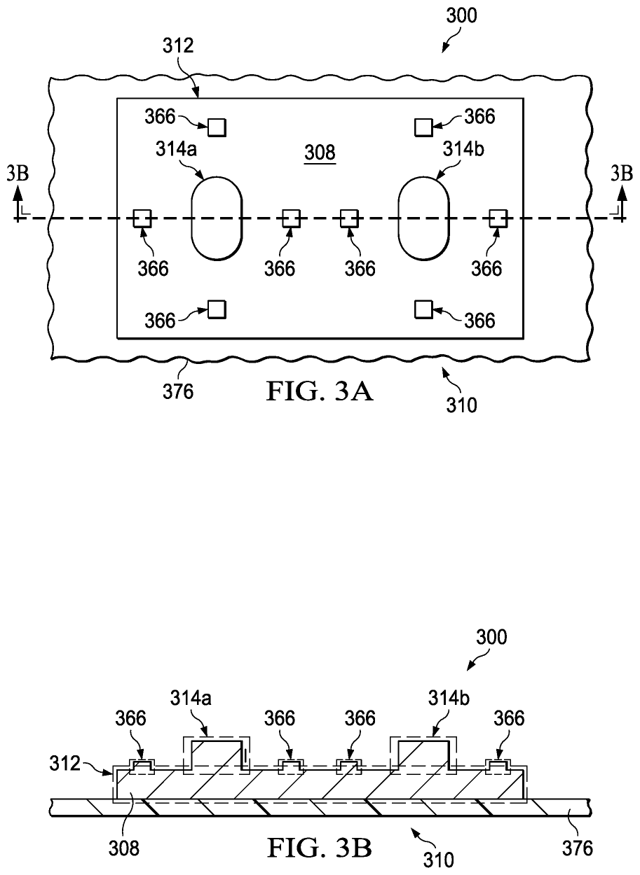

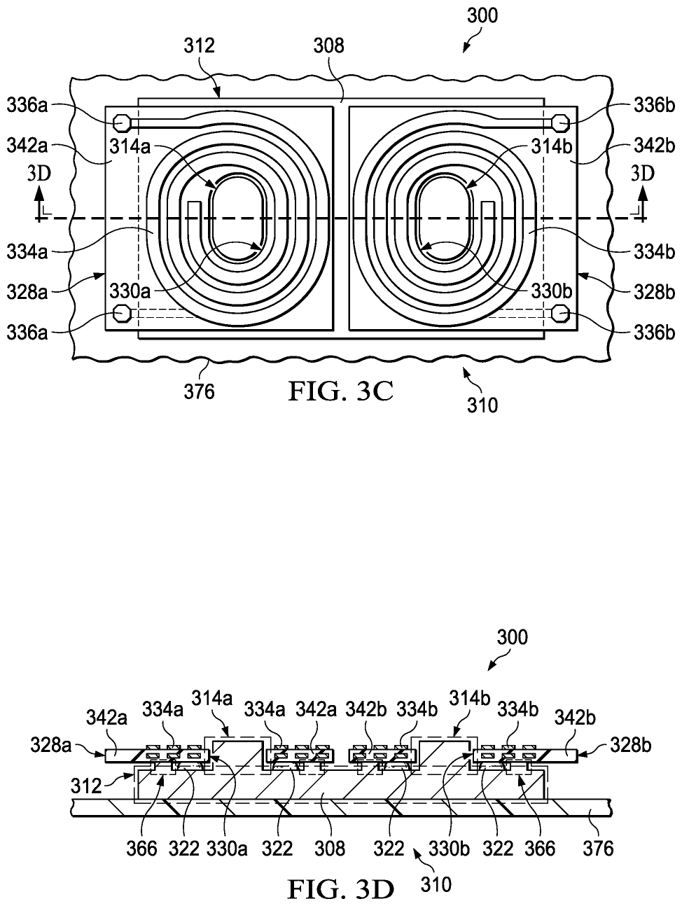

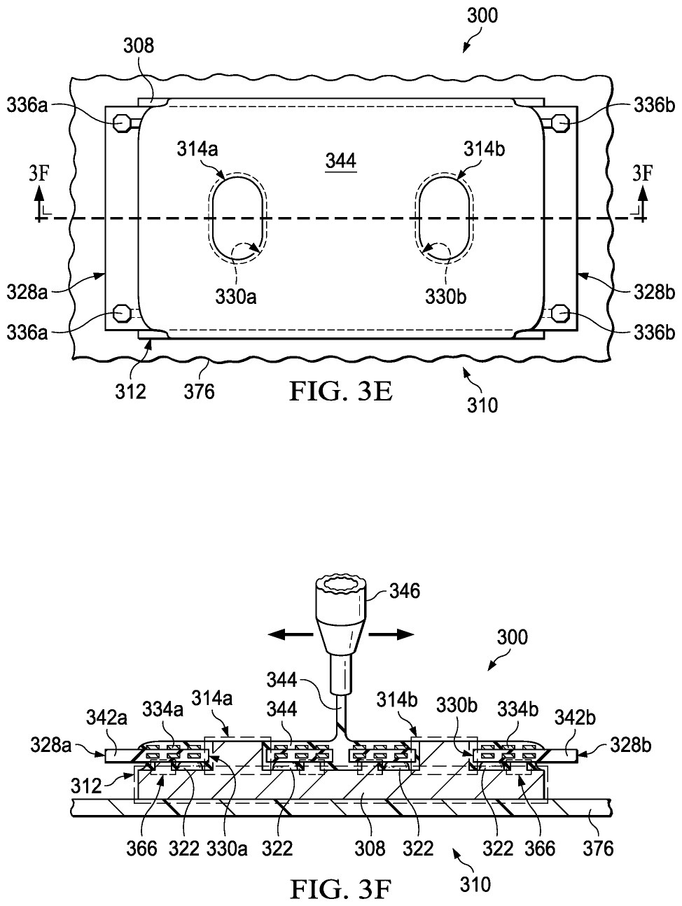

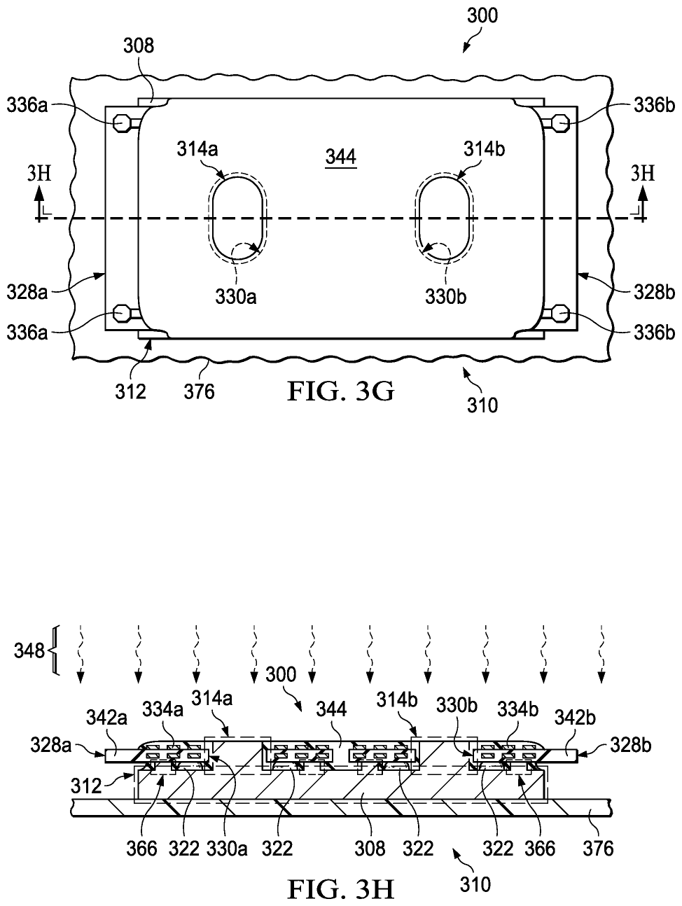

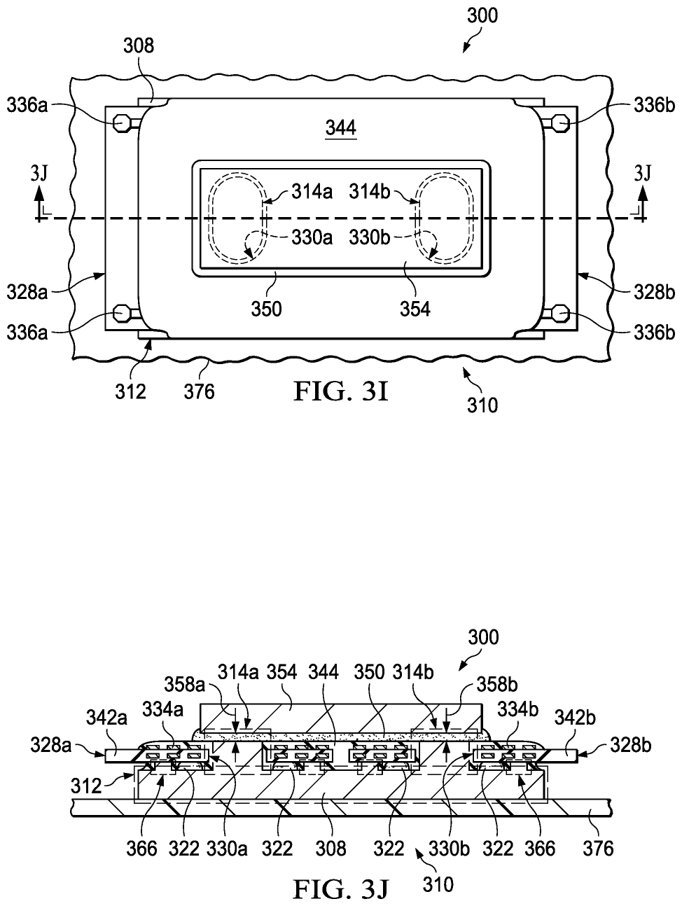

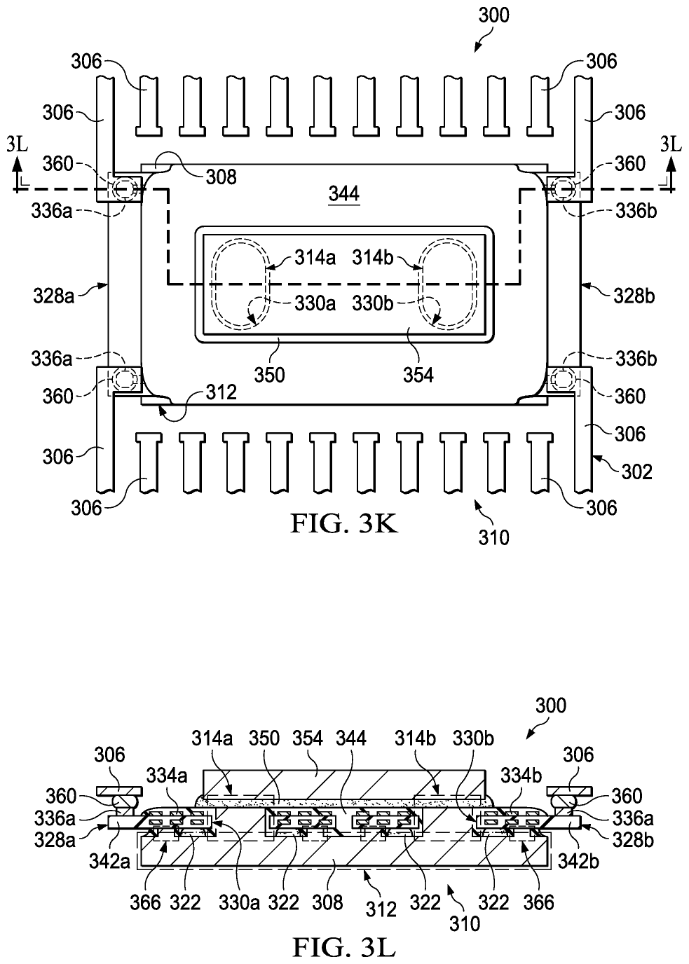

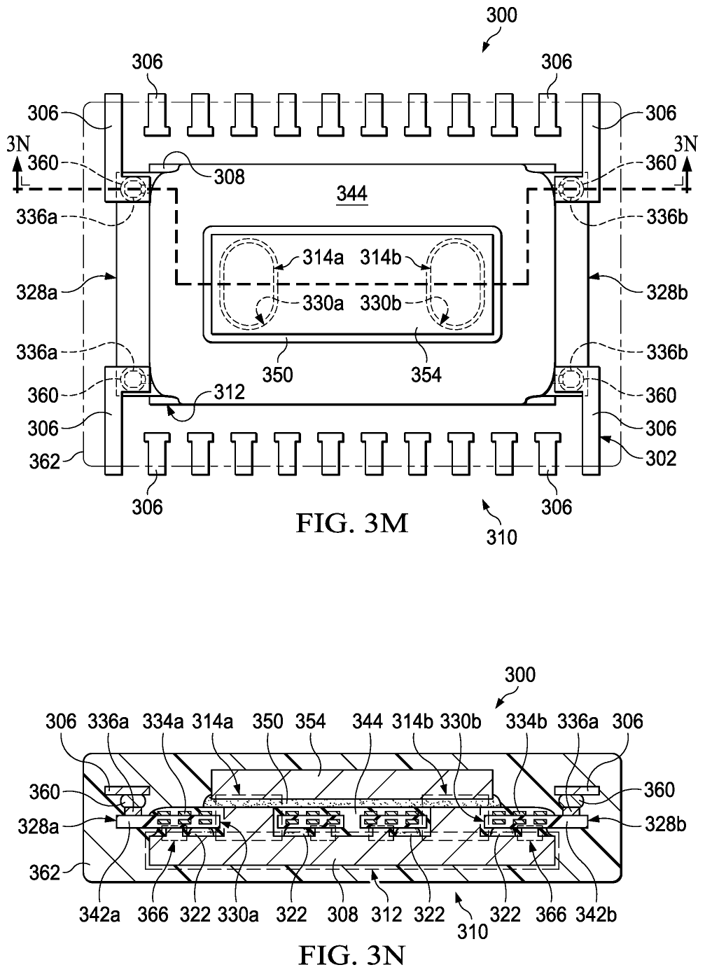

FIG. 3A through FIG. 3N are alternately top views and cross sections of a further example microelectronic device including a magnetic component, depicted in successive stages of a further example method of formation. Referring to FIG. 3A and FIG. 3B, formation of the microelectronic device 300 of this example includes providing a temporary substrate 376. The temporary substrate 376 may be manifested as a rectangular sheet, a round wafer, or other configuration, and have spaces for additional microelectronic devices. The temporary substrate 376 may include metal, glass, silicon, ceramic, or polymer. The temporary substrate 376 may have a coating to facilitate removal from the magnetic component 310 later in the method of formation.

A first magnetic core segment 308 of the magnetic component 310 is temporarily attached to the temporary substrate 376. The first magnetic core segment 308 includes a winding support portion 312 that includes ferromagnetic material. The first magnetic core segment 308 also includes a first center extension portion 314a which extends from the winding support portion 312, and a second center extension portion 314b which also extends from the winding support portion 312, on a same side of the winding support portion 312 as the first center extension portion 314a. The first magnetic core segment 308 may include standoffs 366 extending from the winding support portion 312, similar to the standoffs 266 disclosed in reference to FIG. 2A and FIG. 2B.

The first magnetic core segment 308 may be temporarily attached to the temporary substrate 376 using a releasable adhesive, such as a thermal release adhesive or a UV release adhesive. Alternatively, the first magnetic core segment 308 may be temporarily attached to the temporary substrate 376 using a micropore layer that is free of adhesive. Other materials or structures for temporarily attaching the first magnetic core segment 308 to the temporary substrate 376 are within the scope of this example.

Referring to FIG. 3C and FIG. 3D, a first adhesive material 322 is formed on the winding support portion 312. The first adhesive material 322 may be implemented as a die attach adhesive, and may have the properties, such as viscosity and surface tension, disclosed in reference to the second adhesive material 122 of FIG. 1E and FIG. 1F. The first adhesive material 322 may be formed on the winding support portion 312 in separate dots, as depicted in FIG. 3C and FIG. 3D, or may be formed to cover a majority, or all, of the winding support portion 312.

A first winding lamina 328a is attached to the winding support portion 312 by the first adhesive material 322. The first winding lamina 328a has a first aperture 330a, and includes first winding loops 334a extending completely around the first aperture 330a. The first winding loops 334a are electrically coupled to first connection pads 336a of the first winding lamina 328a. The first winding loops 334a may be configured on more than one level, as depicted in FIG. 3D, separated by first layers, not shown, of a first electrically insulating material 342a. The first winding lamina 328a is disposed on the winding support portion 312 so that the first center extension portion 314a extends through the first aperture 330a, as depicted in FIG. 3C and FIG. 3D.

A second winding lamina 328b is attached to the winding support portion 312 by the first adhesive material 322. The second winding lamina 328b has a second aperture 330b, and includes second winding loops 334b extending completely around the second aperture 330b. The second winding loops 334b are electrically coupled to second connection pads 336b of the second winding lamina 328b. The second winding loops 334b may be configured on more than one level, as depicted in FIG. 3D, separated by second layers, not shown, of a second electrically insulating material 342b. The second winding lamina 328b is disposed on the winding support portion 312 so that the second center extension portion 314b extends through the second aperture 330b, as depicted in FIG. 3C and FIG. 3D.

In this example, a portion of the first winding loops 334a and a portion of the second winding loops 334b may be exposed at surfaces of the first winding lamina 328a and the second winding lamina 328b, respectively, as indicated in FIG. 3C and FIG. 3D. Alternately, the first winding loops 334a and the second winding loops 334b may be covered by the first electrically insulating material 342a and the second electrically insulating material 342b, respectively.

The first winding lamina 328a and the second winding lamina 328b may be positioned over the first adhesive material 322 and pressed into the first adhesive material 322 until the first winding lamina 328a and the second winding lamina 328b contact the standoffs 366, to set desired separations between the winding support portion 312 and the first winding lamina 328a and between the winding support portion 312 and the second winding lamina 328b. The first adhesive material 322 is cured to permanently bond the first winding lamina 328a and the second winding lamina 328b to the winding support portion 312. The first adhesive material 322 may be cured as disclosed in reference to second adhesive material 122 of FIG. 1J. The first adhesive material 322 and the standoffs 366 are not shown in FIG. 3C, to show more clearly the configurations of the first winding loops 334a and the second winding loops 334b.

Referring to FIG. 3E and FIG. 3F, a filler material 344 is formed on the first magnetic core segment 308, the first winding lamina 328a, and the second winding lamina 328b. The filler material 344 fills at least a portion of a space between the first magnetic core segment 308 and the first winding lamina 328a, including in the first aperture 330a around the first center extension portion 314a. The filler material 344 similarly fills at least a portion of a space between the first magnetic core segment 308 and the second winding lamina 328b, including in the second aperture 330b around the second center extension portion 314b. The filler material 344 contacts the first magnetic core segment 308, the first winding lamina 328a, and the second winding lamina 328b. In this example, the filler material 344 may extend over the first winding lamina 328a and the second winding lamina 328b, as depicted in FIG. 3E and FIG. 3F. The filler material 344 leaves the first connection pads 336a and the second connection pads 336b exposed to enable formation of electrical connections to the first connection pads 336a and the second connection pads 336b. The filler material 344 may be free of voids between the first magnetic core segment 308 and the first winding lamina 328a, and between the first magnetic core segment 308 and the second winding lamina 328b, which may advantageously improve reliability of the magnetic component 310 compared to a similar magnetic component having voids. The filler material 344 may be implemented as a underfill adhesive, with the properties disclosed in reference to the filler material 144 of FIG. 1K and FIG. 1L. The filler material 344 may be formed on the first magnetic core segment 308 using a continuous extrusion dispensing apparatus 346, as indicated in FIG. 3F, or using a droplet dispensing apparatus or other methods and equipment.

Referring to FIG. 3G and FIG. 3H, the filler material 344 is cured, converting the filler material 344 to a solid in the spaces between the first magnetic core segment 308, the first winding lamina 328a, and the second winding lamina 328b. After the filler material 344 is cured, the filler material 344 between the first magnetic core segment 308, the first winding lamina 328a, and the second winding lamina 328b may be free of voids, which may advantageously improve reliability of the magnetic component 310. The filler material 344 may be cured by a curing process 348. The curing process 348 may have a thermal profile similar to the fourth curing process 148 disclosed in reference to FIG. 1M and FIG. 1N. The curing process 348 may be implemented as a convection oven heating process, a radiant heating process, as indicated schematically in FIG. 3H, or a hotplate heating process, by way of example. Other implementations of processes for curing the filler material 344 are within the scope of this example.

Referring to FIG. 3I and FIG. 3J, a second adhesive material 350 is formed over the first center extension portion 314a and the second center extension portion 314b of the first magnetic core segment 308, and over the filler material 344 between the first center extension portion 314a and the second center extension portion 314b. The second adhesive material 350 may be formed in a continuous layer, as depicted in FIG. 3I and FIG. 3J. The second adhesive material 350 may have a same composition, or a similar composition, as the first adhesive material 322. The second adhesive material 350 may be formed using a continuous extrusion dispensing apparatus, a screen printing apparatus, or other apparatus.

A second magnetic core segment 354 is placed on the second adhesive material 350. The second magnetic core segment 354 includes ferromagnetic material that extends over the first center extension portion 314a and the second center extension portion 314b, and over the first winding lamina 328a and the second winding lamina 328b between the first center extension portion 314a and the second center extension portion 314b. The second magnetic core segment 354 may have a same composition, or a similar composition, as the first magnetic core segment 308. The second magnetic core segment 354 may be pressed down on the second adhesive material 350 to reduce separations between the second magnetic core segment 354 and the first center extension portion 314a and between the second magnetic core segment 354 and the second center extension portion 314b, and to remove any voids under the second magnetic core segment 354. In some cases, the second adhesive material 350 may be squeezed out of regions between the second magnetic core segment 354 and the filler material 344.

The second adhesive material 350 is subsequently cured to permanently bond the second magnetic core segment 354 to the first magnetic core segment 308. The second adhesive material 350 may be cured as disclosed in reference to second adhesive material 122 of FIG. 1J.

After the second adhesive material 350 is cured, the second adhesive material 350 between the first magnetic core segment 308 and the second magnetic core segment 354 may be free of voids, which may advantageously improve reliability of the magnetic component 310. A first separation 358a between the second magnetic core segment 354 and the first center extension portion 314a and a second separation 358a between the second magnetic core segment 354 and the second center extension portion 314b may each be less than 100 microns.

Having the first separation 358a to be less than 100 microns, and having the second separation 358a to be less than 100 microns, may contribute to providing a low magnetic reluctance path around the first winding loops 334a and the second winding loops 334b through the first center extension portion 314a and the second center extension portion 314b, the winding support portion 312, and the second magnetic core segment 354, that is, a path with a magnetic reluctance at least 100 times lower than a comparable path of air or other nonmagnetic material.

Referring to FIG. 3K and FIG. 3L, a lead frame 302 is provided. The lead frame 302 includes external leads 306 that are electrically conductive. The lead frame 302 of this example may be free of a die pad, as indicated in FIG. 3K and FIG. 3L, or may optionally have a die pad, not shown. The lead frame 302 may have a composition and structure as disclosed for the lead frame 102 of FIG. 1A and FIG. 1B.

Electrical connections 360 are formed between the first connection pads 336a and the external leads 306, and between the second connection pads 336b and the external leads 306. The electrical connections 360 form electrical connections between the first winding loops 334a and the external leads 306 and between the second winding loops 334b and the external leads 306. The electrical connections 360 of this example may be implemented as solder bumps, as depicted in FIG. 3L, or may be implemented as wire bods, ribbon bonds, or micro welds, by way of example. In versions of this example in which the electrical connections 360 are implemented as solder bumps, solder paste containing solder may be formed on the first connection pads 336a and the second connection pads 336b, and the lead frame 302 may be positions so that the external leads 306 are brought into contact with the solder paste. Subsequently, the solder paste is heated to reflow the solder and form the electrical connections 360.

The temporary substrate 376 of FIG. 3I and FIG. 3J is detached from the first magnetic core segment 308. The temporary substrate 376 may be detached by heating the temporary substrate 376 to soften an adhesive between the temporary substrate 376 and the first magnetic core segment 308, for example. In one version of this example, the temporary substrate 376 may be detached after forming the electrical connections 360. In another version, the temporary substrate 376 may be detached before forming the electrical connections 360.

The first winding lamina 328a with the first winding loops 334a, the second winding lamina 328b with the second winding loops 334b, the first magnetic core segment 308, the second magnetic core segment 354, the electrical connections 360, and the external leads 306 connected to the electrical connections 360 provide the magnetic component 310.

Referring to FIG. 3M and FIG. 3N, a package material 362 of the microelectronic device 300 is formed on the magnetic component 310 and portions of the external leads 306. The package material 362 is electrically non-conductive. The package material 362 may be manifested as an encapsulation material, a molding compound, or a potting compound, as examples. The package material 362 may have a composition as disclosed for the package material 162 of FIG. 1U and FIG. 1V. The package material 362 may be formed as disclosed for the package material 162. The package material 362 may fill any gaps between the first winding lamina 328a, the second winding lamina 328b, the first magnetic core segment 308, and the second magnetic core segment 354 that are not filled by the filler material 344 or the second adhesive material 350.

The external leads 306 are severed from the lead frame 302 of FIG. 3K and FIG. 3L to singulate the microelectronic device 300. The external leads 306 may be bent or shaped to provide a desired lead configuration, as depicted in FIG. 3M and FIG. 3N. The microelectronic device 300 of this example is depicted as a quad flat no lead (QFN) package, but may be manifested as having another package type. In an alternate version of this example, the microelectronic device 300 may include additional components, such as semiconductor devices, such as transistors and diodes, or passive components, such as resistors and capacitors, encapsulated by the package material 362.

In an alternate version of this example, the magnetic component 310 may be transferred from the temporary substrate 376 of FIG. 3I and FIG. 3J to a chip carrier. Electrical connections may be formed between the first connection pads 336a and the second connection pads 336b and external leads of the chip carrier by wire bonding, ribbon bonding, micro welding, or solder bumping.

The microelectronic device 300 of this example may advantageously enable a lower profile, that is, a lower vertical thickness, by having the first winding lamina 328a separate from, and adjacent to, the second winding lamina 328b. In versions of this example in which the magnetic component 310 is manifested as a transformer in which the first winding loops 334a include a primary winding and the second winding loops 334b include a secondary winding, having the winding loops 334a and 334b in separate winding lamina 328a and 328b adjacent to each other, with separate center extension portions 314a and 314b, may enable a lower overall vertical thickness compared to having stacked winding lamina around a single center extension portion.

Various features of the examples disclosed herein may be combined in other manifestations of example microelectronic devices. For example, any of the microelectronic devices 100, 200, and 300 may be fabricated on a lead frame, as disclosed in reference to FIG. 1A through FIG. 1V. Any of the microelectronic devices 100, 200, and 300 may be fabricated on a chip carrier, as disclosed in reference to FIG. 2A through FIG. 2P. Any of the magnetic components 110, 210, and 310 may be fabricated on a temporary substrate and transferred to a lead frame or chip carrier, as disclosed in reference to FIG. 3A through FIG. 3N.

Any of the adhesive materials used to form any of the microelectronic devices 100, 200, and 300 may be dispensed by continuous extrusion dispensing processes, screen printing processes, droplet dispensing processes, or stamping processes. Similarly, any of the filler materials 144, 244, and 344 may be dispensed by continuous extrusion dispensing processes, screen printing processes, or droplet dispensing processes. Any of the adhesive materials and any of the filler materials 144, 244, and 344 used to form any of the microelectronic devices 100, 200, and 300 may be cured by radiant heating processes, convection oven heating processes, or hotplate heating processes.

Any of the first magnetic core segments 108, 208, and 308, and any of the second magnetic core segments 154, 254, and 354 may have homogeneous compositions of ferromagnetic material, or may have composite structures in which parts of the first magnetic core segments 108, 208, and 308, or second magnetic core segments 154, 254, and 354 have a first composition of ferromagnetic material, such as iron-based alloy, and other parts have a second composition of ferromagnetic material, such as ferrite ceramic. In particular, the winding support portions 112, 212, and 312 and planar portions of the second magnetic core segments 154, 254, and 354 may have a metal composition to provide mechanical strength, and extending portions such as the center extension portions 114, 214, and 314a and 314b, may have a ferrite ceramic composition or a magnetic particle composition, to facilitate molding to desired dimensions.

Any of the first magnetic core segments 108, 208, and 308 may include standoffs, as disclosed in reference to FIG. 2A through FIG. 2P, or FIG. 3A through FIG. 3N. Any of the microelectronic devices 100, 200, and 300 may be fabricated by partially curing an adhesive material used to attach the corresponding winding lamina 128, 228a, or 328a and 328b to the respective first magnetic core segments 108, 208, and 308.

Any of the winding lamina 128, 228a and 228b, or 328a and 328b may have exposed winding loops 134, 234a and 234b, or 334a and 334b, or may have covered winding loops 134, 234a and 234b, or 334a and 334b. Any of the winding lamina 128, 228a and 228b, or 328a and 328b may have winding loops 134, 234a and 234b, or 334a and 334b separated by layers of electrically insulating material, as disclosed in reference to FIG. 1A through FIG. 1V.

Any of the winding loops 134, 234a and 234b, or 334a and 334b may be electrically coupled to external leads 106, 206, or 306, respectively, by wire bonds, ribbon bonds, micro welds, solder bumps, or any combination thereof.

Any of the magnetic components 110, 210, and 310 may be encapsulated by a packaging material, as disclosed in reference to FIG. 1A through FIG. 1V or FIG. 3A through FIG. 3N.

While various embodiments of the present disclosure have been described above, it should be understood that they have been presented by way of example only and not limitation. Numerous changes to the disclosed embodiments can be made in accordance with the disclosure herein without departing from the spirit or scope of the disclosure. Thus, the breadth and scope of the present invention should not be limited by any of the above described embodiments. Rather, the scope of the disclosure should be defined in accordance with the following claims and their equivalents.

What is claimed is:

1. A microelectronic device, comprising:
a first magnetic core segment having a winding support portion that includes ferromagnetic material and having an extension portion that includes ferromagnetic material extending from the winding support portion;
a winding lamina attached to the winding support portion by an adhesive material, the winding lamina including a winding loop of electrically conductive material surrounding ferromagnetic material;
a filler material between the winding lamina and the first magnetic core segment, the filler material having a composition that is different from the adhesive material;
a second magnetic core segment that includes ferromagnetic material attached to the extension portion; and
electrical connections between the winding loop and external leads of the microelectronic device.

2. The microelectronic device of claim 1, wherein the winding loop extends completely around the extension portion.

3. The microelectronic device of claim 2, wherein the first magnetic core segment includes lateral portions of ferromagnetic material that extend from the winding support portion, the lateral portions being located on opposite sides of the winding loop.

4. The microelectronic device of claim 2, wherein:
the winding lamina is a first winding lamina; and
the winding loop is a first winding loop; and
further including a second winding lamina having a second winding loop of electrically conductive material, the second winding lamina being attached to the first winding lamina, the second winding loop extending completely around the extension portion.

5. The microelectronic device of claim 1, wherein:
the extension portion is a first lateral portion;
the first magnetic core segment includes a second lateral portion of ferromagnetic material extending from the winding support portion;
the first lateral portion and the second lateral portion are located on opposite sides of the winding loop;
the second magnetic core segment includes a core portion of ferromagnetic material that extends through an aperture in the winding lamina; and
the winding loop extends completely around the core portion.

6. The microelectronic device of claim 1, wherein:
the extension portion is a first center extension portion;
the first magnetic core segment includes a second center extension portion of ferromagnetic material extending from the winding support portion;
the winding lamina is a first winding lamina;
the winding loop is a first winding loop; and
the first winding loop extends completely around the first center extension portion; and
further including a second winding lamina having a second winding loop of electrically conductive material, the second winding lamina being attached to the winding support portion, the second winding loop extending completely around the second center extension portion.

7. The microelectronic device of claim 1, wherein:
the adhesive material includes first filler particles;
the filler material includes second filler particles; and
the adhesive material has a higher volume percent of the first filler particles than the filler material has of the second filler particles.

8. The microelectronic device of claim 1, wherein the adhesive material has a color that is different from the filler material.

9. The microelectronic device of claim 1, wherein a space between the extension portion and the second magnetic core segment is less than 100 microns.

10. The microelectronic device of claim 1, wherein the winding loop is configured on more than one level, separated by layers of electrically insulating material of the winding lamina.

11. The microelectronic device of claim 1, wherein the first magnetic core segment includes standoffs on the winding support portion between the winding lamina and the winding support portion.

12. A method of forming a microelectronic device, comprising:
attaching a winding lamina to a winding support portion of a first magnetic core segment, the winding support portion including ferromagnetic material, the first magnetic core segment including an extension portion that includes ferromagnetic material extending from the winding support portion, the winding lamina including a winding loop of electrically conductive material;
forming a filler material between the winding lamina and the first magnetic core segment;
subsequently attaching a second magnetic core segment to the extension portion, the second magnetic core segment including ferromagnetic material; and
forming electrical connections between the winding loop and external leads of the microelectronic device.

13. The method of claim 12, wherein attaching the winding lamina to the winding support portion includes forming an adhesive material on the winding support portion, and disposing the winding lamina on the adhesive material.

14. The method of claim 13, wherein the adhesive material has a viscosity of 20,000 centipoise to 300,000 centipoise when the adhesive material is formed on the winding support portion.

15. The method of claim 13, wherein the filler material includes less than 20 volume percent of filler particles.

16. The method of claim 13, wherein attaching the winding lamina to the winding support portion further includes partially curing the adhesive material after forming the adhesive material on the winding support portion and before disposing the winding lamina on the adhesive material.

17. The method of claim 12, wherein the filler material has a viscosity of 10,000 centipoise to 60,000 centipoise when the filler material is formed between the winding lamina and the first magnetic core segment.

18. The method of claim 12, wherein the winding lamina is a first winding lamina, and further including attaching a second winding lamina to the first winding lamina before attaching the second magnetic core segment to the extension portion.

19. The method of claim 12, wherein the winding lamina is a first winding lamina, and further including attaching a second winding lamina to the winding support portion before attaching the second magnetic core segment to the extension portion.

20. The method of claim 12, wherein the filler material covers the winding lamina under the second magnetic core segment.
